(19) United States
(12) Patent Application Publication
(10) Pub. No.: US 2024/0393141 A1
(43) Pub. Date: Nov. 28, 2024

(54) CONTACT DETECTING APPARATUS

(71) Applicant: Sumitomo Riko Company Limited, Aichi (JP)

(72) Inventors: Tetsuyoshi Shibata, Aichi (JP); Masaki Nasu, Aichi (JP); Takuma Maeda, Aichi (JP); THIN QUANG NGO, Aichi (JP); Takahiro KODA, Aichi (JP); Takemasa Okumura, Aichi (JP)

(73) Assignee: Sumitomo Riko Company Limited, Aichi (JP)

(21) Appl. No.: 18/796,305

(22) Filed: Aug. 7, 2024

Related U.S. Application Data
(63) Continuation of application No. PCT/JP2023/034726, filed on Sep. 25, 2023.

(30) Foreign Application Priority Data
Sep. 30, 2022 (JP) 2022-158514

(51) Int. Cl. G01D 5/24

(52) U.S. Cl. CPC G01D 5/24

(57) ABSTRACT

A contact detecting apparatus comprises an electrostatic sensor, a first bridge capacitor, a charge/discharge switching element, a control device, and a measuring instrument. The electrostatic sensor is configured to have an electrostatic capacitance that changes in accordance with at least one of an area contacted by a conductor and a distance to the conductor, and is configured to have a time constant τ hat changes depending on an electrical resistance corresponding to a distance from a first measurement position; and in a charging process, the measuring instrument detects a position where the conductor is in contact with the electrostatic sensor based on a first potential first sampling value, which is a first potential acquired at a first sampling time point, and a first potential second sampling value, which is the first potential acquired at a second sampling time point after a predetermined time has elapsed from the first sampling time point.

### CROSS-REFERENCE TO RELATED APPLICATION

The present application is a continuation of PCT/JP2023/034726, filed on Sep. 25, 2023, and is related to and claims priority from Japanese Patent Application No. 2022-158514 filed on Sep. 30, 2022. The entire contents of the aforementioned application are hereby incorporated by reference herein.

### TECHNICAL FIELD

The disclosure relates to a contact detecting apparatus.

### RELATED ART

A contact detecting apparatus that detects contact of a human body based on a change in electrostatic capacitance has been proposed in, for example, Patent Document 1 (Japanese Patent Application Laid-Open No. 2015-55589).

This contact detecting apparatus of Patent Document 1 includes a flexible sensor body formed in a sheet shape. The sensor body includes a plurality of rows of first electrodes and a plurality of columns of second electrodes. The first electrodes in each of the plurality of rows of first electrodes are formed in a strip shape and arranged in parallel to each other (see FIG. 11 of Patent Document 1). The second electrodes in each of the plurality of columns of second electrodes are formed in a strip shape and are arranged in parallel to each other. The plurality of rows of first electrodes and the plurality of columns of second electrodes are arranged to cross each other.

The plurality of rows of first electrodes and the plurality of columns of second electrodes are arranged in a matrix. Thus, when a conductor such as a human hand or finger comes into contact with the sensor body, the position and area where the conductor comes into contact can be detected by the plurality of rows of first electrodes and the plurality of columns of second electrodes arranged in a matrix.

Patent Document 2 (Japanese Patent Application Laid-Open No. 2019-196904) has proposed a pressure sensing device that can detect both a pressed position and a pressing force. This pressure sensing device includes a pressure sensing part 2 having a dielectric, a first electrode having a predetermined volume resistivity, and a second electrode. The pressure sensing device further includes a first measurement instrument 30a connected to a first left terminal 21a located at the left end of the first electrode and a second left terminal 22a located at the left end of the second electrode, and a second measurement instrument 30b connected to a first right terminal 21b located at the right end of the first electrode and a second right terminal 22b located at the right end of the second electrode.

The pressure sensing part 2 forms an RC circuit with an electrostatic capacitance C between the electrodes and an electrical resistance R mainly of the first electrode. The pressure sensing part is deformed by a pressing force applied from outside, which causes the electrostatic capacitance C to change. In addition, since the first electrode has a predetermined volume resistivity, the electrical resistance between the pressed position and the first left terminal 21a changes according to the distance between the pressed position where external pressure is added to the pressure sensing part and the first left terminal 21a, and similarly the electrical resistance between the pressed position and the first right terminal 21b changes. The pressing force and the pressed position can be obtained using an RC delay time in the measurement value of the first measurement instrument 30a and an RC delay time in the measurement value of the second measurement instrument 30b.

However, according to the technology described in Patent Document 1, the plurality of rows of first electrodes and the plurality of columns of second electrodes are arranged in a matrix, so it is necessary to increase the wirings and the terminals for connecting the wirings, which causes problems that the number of parts increases and the structure becomes complicated.

According to the technology described in Patent Document 2, in order to obtain the pressing force and the pressed position, it is necessary to use the measurement value of the first measurement instrument and the measurement value of the second measurement instrument, which are respectively connected to terminals at different positions. That is, two measurement instruments are required in order to obtain the pressing force and the pressed position. Thus, there are problems that the number of parts increases and the structure becomes complicated.

The disclosure provides a contact detecting apparatus that is capable of detecting at least one of a contact position and a contact area with a simple configuration.

### SUMMARY

One aspect of the disclosure provides a contact detecting apparatus, including:
an electrostatic sensor for detecting contact of a conductor, the electrostatic sensor including an application electrode to which an input voltage that is a constant voltage is applied from a power source, a measurement electrode which is disposed opposite to the application electrode and whose potential is measured, and a dielectric which is disposed between the application electrode and the measurement electrode;
a first bridge capacitor connected in series between a first measurement position of the measurement electrode and a ground potential;
a charge/discharge switching element connected in series between the measurement electrode and the ground potential and connected in parallel to the first bridge capacitor, and discharging the potential of the measurement electrode to the ground potential when in a closed state;
a control device executing a process of discharging the potential of the measurement electrode to the ground potential by setting a state in which the input voltage is not applied to the application electrode and setting the charge/discharge switching element to the closed state, and a process of charging the electrostatic sensor by setting the charge/discharge switching element to an open state and setting a state in which the input voltage is applied to the application electrode after the process of discharging; and
a measuring instrument acquiring a first potential between the first measurement position of the measurement electrode and the first bridge capacitor in the process of charging, in which
the electrostatic sensor is configured so that an electrostatic capacitance changes in response to at least one of an area of contact with the conductor and a distance from the conductor, and is configured so that a time constant changes due to an electrical resistance according to a distance from the first measurement position, and
the measuring instrument detects a position where the conductor is in contact with the electrostatic sensor based on a first potential first sampling value and a first potential second sampling value in the process of charging, in which the first potential first sampling value is the first potential acquired at a first sampling time point after a predetermined time has elapsed since start of charging the electrostatic sensor, and the first potential second sampling value is the first potential acquired at a second sampling time point after a predetermined time has elapsed since the first sampling time point.

According to one aspect of the disclosure, at least one of the contact position and the contact area where a conductor comes into contact with the electrostatic sensor can be detected with a simple configuration using one measuring instrument.

It should be noted that the reference numerals in parentheses described in the claims indicate the corresponding relationship with the specific means described in the following embodiments, and are not intended to limit the technical scope of the disclosure.

### BRIEF DESCRIPTION OF DRAWINGS

FIG. 1 is a front view showing the steering wheel to which the contact detecting apparatus of the first embodiment is applied.

FIG. 2 is a cross-sectional view taken along the line II-II of FIG. 1.

FIG. 3 is a partially enlarged cross-sectional view of the electrostatic sensor of the first embodiment, and is a cross-sectional view taken along the line III-III of FIG. 4.

FIG. 4 is a partially cutaway plan view showing the electrostatic sensor of the first embodiment.

FIG. 5 is a block diagram showing the configuration of the contact detecting apparatus of the first embodiment.

FIG. 6 is a timing chart of the operation of the charge/discharge switching element, the first input switching element, and the input potential and output potential of the electrostatic sensor in the first embodiment.

FIG. 7 is a graph showing a change over time in the output voltage of the electrostatic sensor in the process of charging the electrostatic sensor of the first embodiment.

FIG. 8 is a schematic diagram showing a change in electrostatic capacitance due to the approach and contact of a conductor such as a finger in the electrostatic sensor of the first embodiment.

FIG. 9 is a schematic cross-sectional view showing a state where a finger comes into contact with the electrostatic sensor of the first embodiment.

FIG. 10 is a schematic cross-sectional view showing a state where a hand comes into contact with the electrostatic sensor of the first embodiment.

FIG. 11 is a graph showing changes over time in the first voltage when a hand comes into contact with the electrostatic sensor of the first embodiment, the first voltage when a finger comes into contact with the electrostatic sensor of the first embodiment, and the first voltage in a state where nothing is in contact with the electrostatic sensor of the first embodiment.

FIG. 12 is a schematic cross-sectional view showing the currents flowing through the application electrode and the measurement electrode when a finger comes into contact with the electrostatic sensor of the first embodiment.

FIG. 13 is a graph showing a change over time in the first potential in the electrostatic sensor shown in FIG. 12.

FIG. 14 is a schematic cross-sectional view showing the currents flowing through the application electrode and the measurement electrode when a finger comes into contact with a position different from that of the electrostatic sensor shown in FIG. 12.

FIG. 15 is a graph showing a change over time in the first potential in the electrostatic sensor shown in FIG. 14.

FIG. 16 is a flowchart showing the operation of the contact detecting apparatus of the first embodiment.

FIG. 17 is a block diagram showing the configuration of the contact detecting apparatus of the second embodiment.

FIG. 18 is a schematic cross-sectional view showing the currents flowing through the application electrode and the measurement electrode when a finger comes into contact with the electrostatic sensor of the second embodiment.

FIG. 19 is a schematic cross-sectional view showing the currents flowing through the application electrode and the measurement electrode when a finger comes into contact with a position different from that of the electrostatic sensor shown in FIG. 18.

FIG. 20 is a block diagram showing the configuration of the contact detecting apparatus of the third embodiment.

FIG. 21 is a schematic cross-sectional view showing the currents flowing through the application electrode and the measurement electrode when a finger comes into contact with the electrostatic sensor of the third embodiment.

FIG. 22 is a graph showing changes over time in the first potential and the second voltage in the electrostatic sensor shown in FIG. 21.

FIG. 23 is a schematic cross-sectional view showing the currents flowing through the application electrode and the measurement electrode when a finger comes into contact with a position different from that of the electrostatic sensor shown in FIG. 21.

FIG. 24 is a graph showing changes over time in the first potential and the second voltage in the electrostatic sensor shown in FIG. 23.

FIG. 25 is a block diagram showing the configuration of the contact detecting apparatus of the fourth embodiment.

FIG. 26 is a schematic cross-sectional view showing the currents flowing through the application electrode and the measurement electrode when the first cycle is executed in the contact detecting apparatus of the fourth embodiment and a finger comes into contact with the electrostatic sensor.

FIG. 27 is a schematic cross-sectional view showing the currents flowing through the application electrode and the measurement electrode when the second cycle is executed in the contact detecting apparatus of the fourth embodiment and a finger comes into contact with the electrostatic sensor.

FIG. 28 is a flowchart showing the operation of the contact detecting apparatus of the fourth embodiment.

FIG. 29 is a flowchart showing the first cycle of the fourth embodiment.

FIG. 30 is a flowchart showing the second cycle of the fourth embodiment.

FIG. 31 is a partially enlarged cross-sectional view showing the electrostatic sensor of the fifth embodiment.

### DESCRIPTION OF EMBODIMENTS

### First Embodiment

### 1. Configuration of the Steering Wheel 1

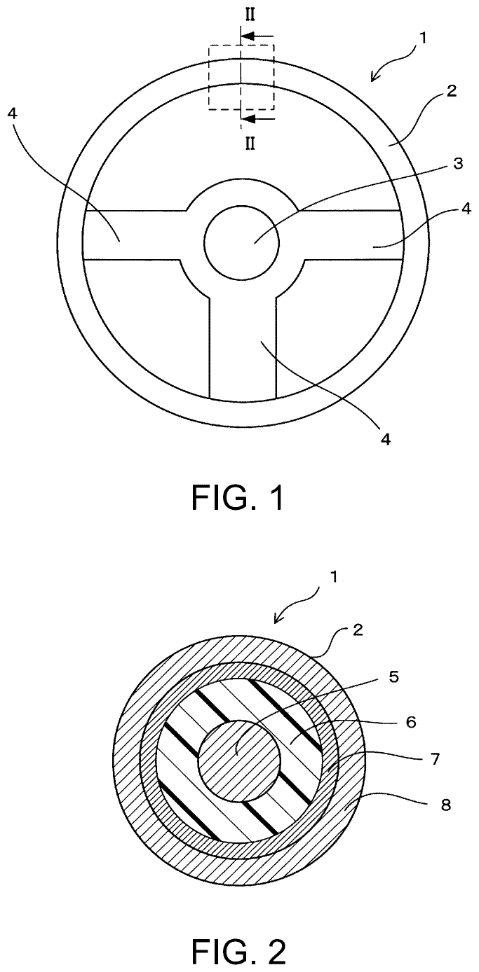

The first embodiment in which a contact detecting apparatus 10 according to the disclosure is applied to a steering wheel 1 of a vehicle (not shown) will be described. First, the structure of the steering wheel 1 will be described with reference to FIG. 1 to FIG. 2. As shown in FIG. 1, the steering wheel 1 includes a ring portion 2 formed in a circular ring shape, a core portion 3 formed smaller than the ring portion 2 and disposed radially inside the ring portion 2, and a plurality of (three in this embodiment) connection portions 4 that connect the core portion 3 and the ring portion 2. However, the number of connection portions 4 is not particularly limited, and may be one or two, or four or more.

As shown in FIG. 2, the ring portion 2 includes a core body 5, a resin inner layer material 6, an electrostatic sensor 7, and a skin material 8. The core body 5 constitutes the central portion of the ring portion 2 and is formed in a shape corresponding to the shape of the ring portion 2. That is, the core body 5 is formed in a circular ring shape and has a circular cross section perpendicular to the axis. Here, the cross-sectional shape of the core body 5 perpendicular to the axis is not limited to a circular shape, but may be any shape such as an elliptical shape, an egg shape, a U-shape, a C-shape, or a polygonal shape. The core body 5 in this embodiment is made of metal such as aluminum or magnesium, and has electrical conductivity. The material of the core body 5 can be a material other than metal.

The resin inner layer material 6 covers the outer surface of the core body 5 over the entire circumference of the ring shape of the core body 5 and over the entire circumference of the circular cross-sectional shape of the core body 5. In this embodiment, the cross section of the resin inner layer material 6 perpendicular to the axis is formed in a circular shape. If the core body 5 has a U-shaped cross section perpendicular to the axis, the resin inner layer material 6 is filled not only on the radial outside of the cross section of the core body 5 perpendicular to the axis, but also in the U-shaped recess of the core body 5. The resin inner layer material 6 is molded on the outer surface side of the core body 5 by injection molding, and is directly bonded to the outer surface of the core body 5. The cross-sectional shape of the resin inner layer material 6 perpendicular to the axis is not limited to a circular shape, but may be any shape such as an egg shape, an elliptical shape, or a polygonal shape. Foamed urethane resin, for example, is used as the resin inner layer material 6. However, it is also possible to use non-foamed resin as the resin inner layer material 6.

The electrostatic sensor 7 is disposed on the outer surface of the resin inner layer material 6. The electrostatic sensor 7 is configured so that when a conductor (not shown) such as a finger or a hand comes into contact with or approaches the electrostatic sensor 7, an electrostatic capacitance equivalent value of the electrostatic sensor 7 changes. The electrostatic sensor 7 according to this embodiment is a steering wheel sensor that is applied to the steering wheel 1 of the vehicle. The electrostatic sensor 7 will be described in detail later.

The skin material 8 covers the outer surface of the electrostatic sensor 7 (the surface of the electrostatic sensor 7 on the side opposite to the resin inner layer material 6) over the entire circumference of the electrostatic sensor 7. That is, as will be described later, in a case where a measurement electrode 22 is exposed on a first surface 24 side of a dielectric 23, the skin material 8 also functions as a covering material of the measurement electrode 22. The skin material 8 is molded by injection molding, and is wrapped on the outer surface side of the electrostatic sensor 7 and bonded to the outer surface of the electrostatic sensor 7. The skin material 8 is made of, for example, urethane resin. The outer surface of the skin material 8 constitutes a design surface. Thus, it is preferable to use non-foamed urethane resin or slightly foamed urethane resin as the skin material 8.

### 2. Configuration of the Electrostatic Sensor

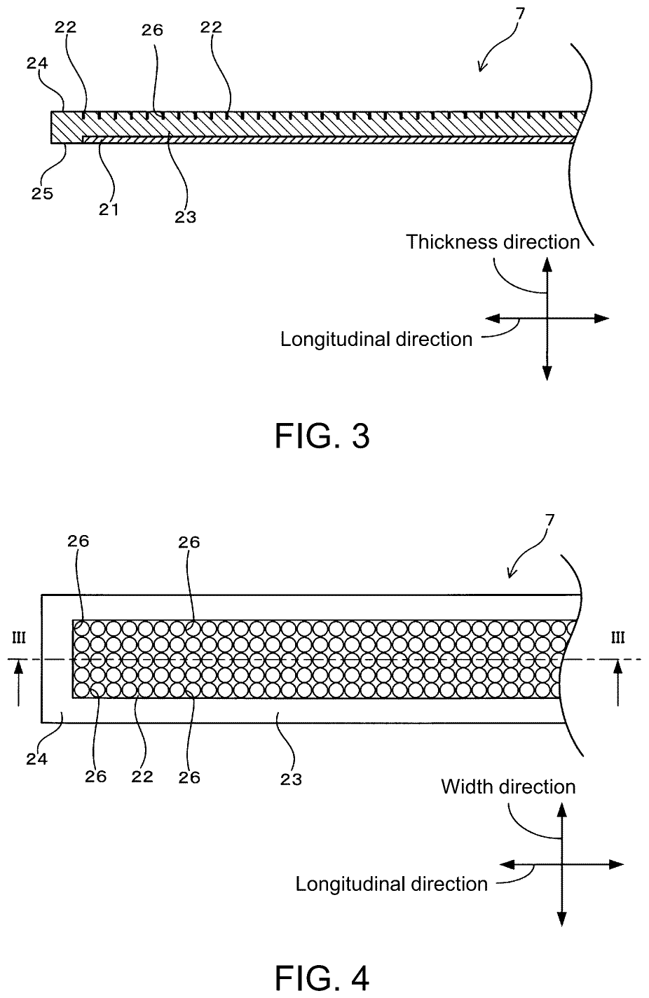

Next, the configuration of the electrostatic sensor 7 will be described with reference to FIG. 3 and FIG. 4. The electrostatic sensor 7 includes an application electrode 21, the measurement electrode 22, and the dielectric 23. The application electrode 21 receives an input voltage Vin, which is a constant voltage, from a power source 41, which will be described later. The measurement electrode 22 is disposed opposite to the application electrode 21 and measures the potential. The dielectric 23 is disposed between the application electrode and the measurement electrode. The application electrode 21 and the measurement electrode 22 have electrical conductivity and are formed in a layered shape.

The application electrode 21 is disposed on a second surface 25 of the dielectric 23. The application electrode 21 is formed slightly smaller than the dielectric 23 and has a similar shape. Thus, an edge portion of the second surface 25 of the dielectric 23 is exposed from an edge portion of the application electrode 21.

The measurement electrode 22 is disposed on the first surface 24 of the dielectric 23. The measurement electrode 22 is formed slightly smaller than the dielectric 23 and has a similar shape. Thus, an edge portion of the first surface 24 of the dielectric 23 is exposed from an edge portion of the measurement electrode 22.

As shown in FIG. 3 and FIG. 4, the measurement electrode 22 has a plurality of through holes 26 that penetrate the measurement electrode 22 in the thickness direction. The through holes 26 are disposed side by side in the longitudinal direction of the measurement electrode 22. Further, the through holes 26 are disposed side by side in the width direction perpendicular to the longitudinal direction of the measurement electrode 22. The inner shape of the through hole 26 is a circular shape. The plurality of through holes 26 are formed to have the same shape and size. However, the through holes 26 may not be disposed side by side in the longitudinal direction, and may not be disposed side by side in the width direction. Furthermore, the inner shape of the plurality of through holes 26 is not limited to a circular shape, but may be a polygonal shape such as a square shape, or an oval shape, and any shape can be selected. In addition, the plurality of through holes 26 are not limited to having the same shape and size, but may be formed in any shape or size as appropriate.

As shown in FIG. 3, in this embodiment, the application electrode 21 is formed flush with the second surface 25 of the dielectric 23. Moreover, the measurement electrode 22 is formed flush with the first surface 24 of the dielectric 23. In this embodiment, the inside of the plurality of through holes 26 is filled with the dielectric 23. However, the application electrode 21 may protrude from the second surface 25 of the dielectric 23, and the measurement electrode 22 may protrude from the first surface 24 of the dielectric 23.

The dielectric 23 is formed to contain, for example, an elastomer as a main component. Therefore, the dielectric 23 is flexible. In other words, the dielectric 23 has flexibility and is configured to be extensible in the planar direction. The dielectric 23 is formed to contain, for example, a thermoplastic material, particularly a thermoplastic elastomer, as a main component. The dielectric 23 may be made of a thermoplastic elastomer itself, or may be made mainly of an elastomer that is crosslinked by heating a thermoplastic elastomer as a material.

Further, the dielectric 23 may contain rubber, resin, or other materials other than a thermoplastic elastomer. For example, in the case where the dielectric 23 contains rubber such as ethylene-propylene rubber (EPM, EPDM), the flexibility of the dielectric 23 is improved. From the viewpoint of improving the flexibility of the dielectric 23, the dielectric 23 may contain a flexibility-imparting component such as a plasticizer. Furthermore, the dielectric 23 may be made mainly of a reactive curing elastomer or a thermosetting elastomer.

Furthermore, the dielectric 23 is preferably a material with good thermal conductivity. Therefore, the dielectric 23 may use a thermoplastic elastomer having high thermal conductivity, or may contain a filler that can increase thermal conductivity.

The application electrode 21 is disposed on the second surface 25 side of the dielectric 23, and the measurement electrode 22 is disposed on the first surface 24 side of the dielectric 23. The application electrode 21 and the measurement electrode 22 have electrical conductivity. Furthermore, the application electrode 21 and the measurement electrode 22 are flexible. In other words, the application electrode 21 and the measurement electrode 22 have flexibility and are configured to be extensible in the planar direction.

The application electrode 21 and the measurement electrode 22 may be made of an electrically conductive elastomer. In the case where the application electrode 21 and the measurement electrode 22 are made of an electrically conductive elastomer, the application electrode 21 and the measurement electrode 22 are formed by using an elastomer as a base material and by containing an electrically conductive filler. The elastomer that is the base material of the application electrode 21 and the measurement electrode 22 may have the same main component as the dielectric 23, or may use a different material. The application electrode 21 and the measurement electrode 22 are bonded to the dielectric 23 by fusion (thermal fusion) with each other.

The application electrode 21 and the measurement electrode 22 may be made of an electrically conductive cloth. The electrically conductive cloth is a woven or nonwoven fabric made of electrically conductive fibers. Here, the electrically conductive fibers are formed by coating the surface of flexible fibers with an electrically conductive material. The electrically conductive fibers are formed, for example, by plating the surface of resin fibers such as polyethylene with copper or nickel. In this case, the application electrode 21 and the measurement electrode 22 are bonded to the dielectric 23 by fusion (thermal fusion) of the dielectric 23 itself.

The application electrode 21 and the measurement electrode 22 may be made of a metal foil. The metal foil may be any conductive metal material such as a copper foil or an aluminum foil. Furthermore, the application electrode 21 and the measurement electrode 22 are bonded to a sensor sheet by fusion (thermal fusion) of the dielectric 23 itself, in the same manner as in the case of an electrically conductive cloth.

The application electrode 21 may or may not have a through hole penetrating the application electrode 21 in the thickness direction. In the case where the application electrode 21 does not have a through hole, the measurement electrode 22 has the plurality of through holes 26, so that the electrical resistance value of the measurement electrode 22 can be made greater than the electrical resistance value of the application electrode 21. In detail, the electrical resistance value per unit length of the measurement electrode 22 in the longitudinal direction is configured to be greater than the electrical resistance value per unit length of the application electrode 21.

On the other hand, in the case where the application electrode 21 has a through hole, by forming the hole diameter of the through holes 26 of the measurement electrode 22 to be greater than the hole diameter of the through hole of the application electrode 21, the electrical resistance value of the measurement electrode 22 can be made greater than the electrical resistance value of the application electrode 21.

### 3. Overall Configuration of the Contact Detecting Apparatus 10

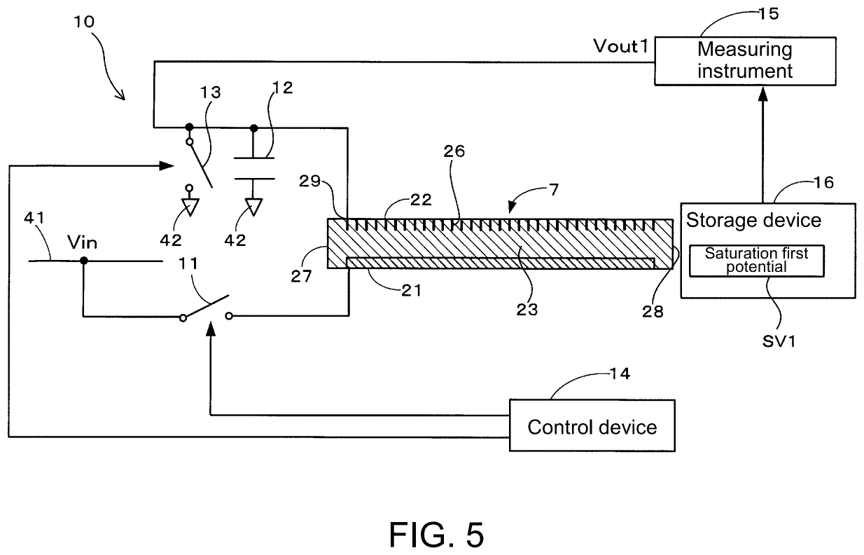

As shown in FIG. 5, the contact detecting apparatus 10 includes the electrostatic sensor 7, a first input switching element 11, a first bridge capacitor 12, a charge/discharge switching element 13, a control device 14, and a measuring instrument 15.

The first input switching element 11 is disposed between the power source 41 and the application electrode 21 and turns on or off the input voltage Vin applied from the power source 41 to the application electrode 21. The power source 41 according to this embodiment is a power source line connected to a DC power source (not shown). The electrostatic sensor 7 is formed in a shape that is elongated in the longitudinal direction (see FIG. 3 and FIG. 4). The electrostatic sensor 7 has a first end portion 27 and a second end portion 28 at both ends in the longitudinal direction. The first end portion 27 in the longitudinal direction of the application electrode 21 is connected to the power source 41.

The first bridge capacitor 12 is connected in series between the first end portion 27 in the longitudinal direction of the measurement electrode 22 and a ground potential 42. The first end portion 27 in the longitudinal direction of the measurement electrode 22 is an example of a first measurement position 29 of the measurement electrode 22.

The charge/discharge switching element 13 is connected in series between the first measurement position 29 of the measurement electrode 22 and the ground potential 42, and is connected in parallel to the first bridge capacitor 12. When the charge/discharge switching element 13 is in the closed state, the charge/discharge switching element 13 discharges the potential of the measurement electrode 22 to the ground potential 42.

The control device 14 is a microcomputer including a CPU (not shown), a RAM (not shown), a ROM (not shown), etc. The control device 14 controls the first input switching element 11 to the open state or the closed state. In addition, the control device 14 controls the charge/discharge switching element 13 to the open state or the closed state.

The control device 14 sets the first input switching element 11 to the open state and sets the charge/discharge switching element 13 to the closed state. Thus, the control device 14 executes a process of discharging the potential of the measurement electrode 22 to the ground potential 42. After the process of discharging the potential of the measurement electrode 22 to the ground potential 42, the control device 14 sets the charge/discharge switching element 13 to the open state and sets the first input switching element 11 to the closed state. Thus, the control device 14 executes a process of charging the electrostatic sensor 7.

In the process of charging the electrostatic sensor 7, the measuring instrument 15 acquires a first potential V1 between the first measurement position 29 of the measurement electrode 22 and the first bridge capacitor 12.

The storage device 16 stores a saturation first potential SV1. The saturation first potential SV1 is the first potential V1 when the potential of the measurement electrode 22 is saturated in a state where a conductor is in contact with the entire surface of the electrostatic sensor 7 on the measurement electrode 22 side in the process of charging the electrostatic sensor 7.

### 4. Electrostatic Sensor 7

### (1) Electrostatic Capacitance Measuring Method of the Electrostatic Sensor 7

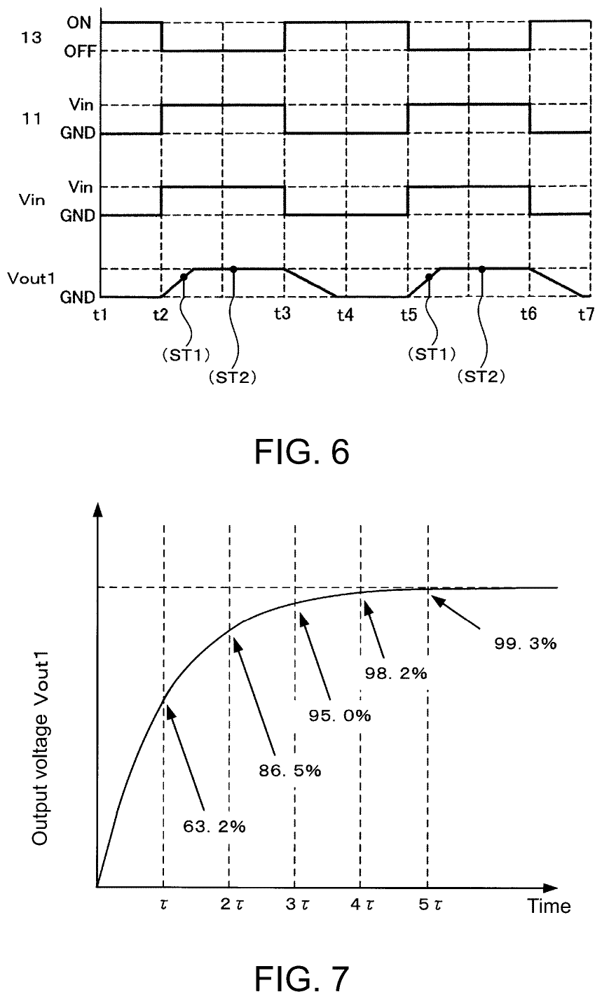

Next, the relationship between the timing of opening and closing the charge/discharge switching element 13 executed by the control device 14, and the potential Vin on one end side of the electrostatic sensor 7 and the output voltage Vout will be described with reference to FIG. 6. In t1 to t2, the charge/discharge switching element 13 is turned ON (closed state). Further, the first input switching element 11 is connected to the ground potential 42 side. Therefore, the potential Vin on one end side of the electrostatic sensor 7 becomes the ground potential 42.

By the above operation, the electric charge of the electrostatic sensor 7 is discharged via the charge/discharge switching element 13. As a result, the potential (output voltage) Vout between the electrostatic sensor 7 and the first bridge capacitor 12 becomes the ground potential 42 as the reference state. That is, before the above operation, the output voltage Vout is indefinite, but the above operation sets the output voltage Vout to the ground potential 42.

Subsequently, in t2 to t4, the charge/discharge switching element 13 is turned OFF (open state), and the first input switching element 11 is connected to the power source 41 side. Therefore, the potential Vin on one end side of the electrostatic sensor 7 becomes the input voltage Vin. By the above operation, the electrostatic sensor 7 is charged with electric charge. After charging is started, the measuring instrument 15 measures the output voltage Vout at times (ST1, ST2) after a predetermined time has elapsed.

Subsequently, in t4 to t5, the charge/discharge switching element 13 is turned ON (closed state), and the first input switching element 11 is connected to the ground potential 42 side. By this operation, the potential Vin on one end side of the electrostatic sensor 7 becomes the ground potential 42, and the electric charge of the electrostatic sensor 7 is discharged. That is, the output voltage Vout becomes the ground potential 42. Subsequently, in t5 to t9, the same operation as in t1 to t5 described above is repeated.

As described above, the first bridge capacitor 12 is connected in series to the electrostatic sensor 7, and the measuring instrument 15 acquires an electrostatic capacitance equivalent value based on the potential on the other end side of the electrostatic sensor 7, that is, the potential (output voltage) Vout between the electrostatic sensor 7 and the first bridge capacitor 12. Here, since the intermediate potential between mere two capacitors is indefinite, the electrostatic capacitance measured using the intermediate potential is not highly accurate.

However, by setting the charge/discharge switching element 13 to the closed state, as described above, the electric charge of the electrostatic sensor 7 is discharged. That is, the output voltage (intermediate potential) Vout becomes the ground potential 42 as the reference state. In other words, by setting the charge/discharge switching element 13 to the closed state, the output voltage Vout can be calibrated.

Then, after discharging, the measuring instrument 15 measures the potential on the other end side of the electrostatic sensor 7 when the charge/discharge switching element 13 is set to the open state and the input voltage Vin is applied to one end side of the electrostatic sensor 7. In other words, the potential measured by the measuring instrument 15 becomes a potential corresponding to the electrostatic sensor 7. Therefore, the contact detecting apparatus 10 is capable of measuring the electrostatic sensor 7 with high accuracy.

### (2) Time Constant τ of the Electrostatic Sensor 7

FIG. 7 shows a change in the output voltage Vout of the electrostatic sensor 7 over time in t2 to t3 described above. As the electrostatic sensor 7 is charged, the output voltage Vout increases, and converges to a saturation voltage when a sufficient time has elapsed.

FIG. 7 shows the percentage of the output voltage Vout of the electrostatic sensor 7 with respect to the saturation voltage when τ, 2τ (twice τ), 3τ (three times τ), 4τ (four times τ), and 5τ (five times τ) have elapsed since the start of charging the electrostatic sensor 7, in regard to a time constant τ in the case where the electrostatic sensor 7 is defined as an RC equivalent circuit. The percentage of the output voltage Vout of the electrostatic sensor 7 with respect to the saturation voltage is 63.2% after τ has elapsed since the start of charging the electrostatic sensor 7, 86.5% after 2τ has elapsed, 95.0% after 3τ has elapsed, 98.2% after 4τ has elapsed, and 99.3% after 5τ has elapsed.

When measuring the output voltage Vout of the electrostatic sensor 7, if the measurement is performed after waiting for the output voltage Vout to converge to a saturation voltage, the measurement requires time, so the efficiency is low. Therefore, the time point at which the output voltage Vout of the electrostatic sensor 7 is measured is set to be five times or more the time constant τ. This makes it possible to improve the efficiency of measuring the output voltage Vout of the electrostatic sensor 7.

### (3) Change in Electrostatic Capacitance of the Electrostatic Sensor 7 Due to Contact or Non-Contact of a Conductor

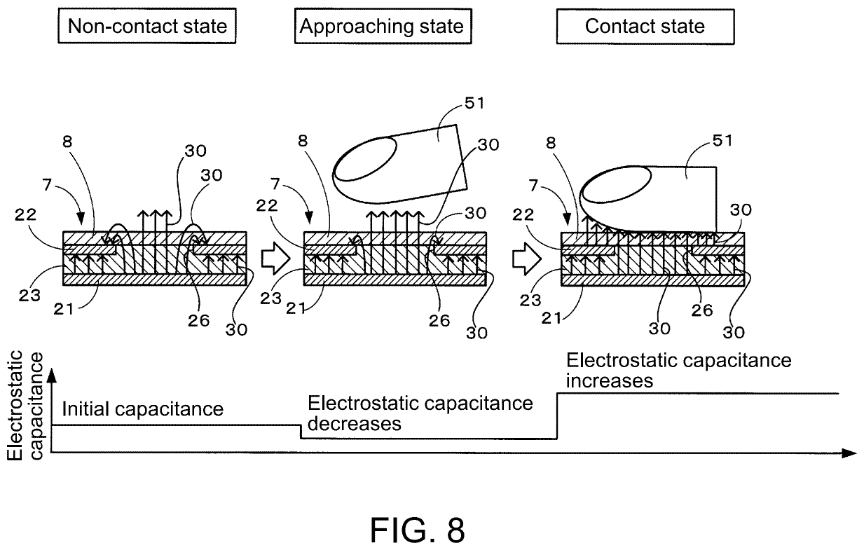

Next, how the electrostatic capacitance of the electrostatic sensor 7 changes depending on whether or not a conductor such as a finger 51 comes into contact with the electrostatic sensor 7 of this embodiment will be illustrated with reference to FIG. 8. For ease of illustration, the size of the finger 51 is exaggerated. However, the state where the conductor is in contact with the electrostatic sensor 7 includes a state where the conductor is in direct contact with the electrostatic sensor 7, and also a state where the conductor is in indirect contact with the electrostatic sensor 7 via the skin material 8.

In the upper part of FIG. 8, the state of the electrostatic sensor 7 and the finger 51 which is a conductor is illustrated. In the middle part of FIG. 8, the state of the electric force lines 30 of the electrostatic sensor 7 in each state is illustrated using partially enlarged cross-sectional views of the electrostatic sensor 7. In the lower part of FIG. 8, the electrostatic capacitance of the electrostatic sensor 7 in each state is illustrated.

The upper left part of FIG. 8 illustrates a “non-contact state.” That is, a state is illustrated in which the finger 51, which is an example of the conductor, is not in contact with the electrostatic sensor 7. The middle left part of FIG. 8 illustrates a state of the electric force lines 30 in a state where the finger 51 is not in contact with the electrostatic sensor 7. In the region where the application electrode 21 and the measurement electrode 22 face each other, the electric force lines 30 are illustrated from the application electrode 21 to the measurement electrode 22. The electric force lines 30 leak out from the through hole 26 of the measurement electrode 22 to a region of the measurement electrode 22 on the opposite side to the application electrode 21. Among the electric force lines 30 leaking out from the through hole 26, the electric force lines 30 located near the hole edge portion of the through hole 26 flow around the hole edge portion of the through hole 26 of the measurement electrode 22 from the region on the opposite side to the application electrode 21 toward the measurement electrode 22.

The electrostatic capacitance of the electrostatic sensor 7 in the non-contact state is illustrated in the lower left part of FIG. 8. In the non-contact state, the electric force lines 30 leak out from the through hole 26 of the measurement electrode 22, so the electrostatic capacitance of the electrostatic sensor 7 is smaller than the electrostatic capacitance in the case where the through hole 26 is not formed in the measurement electrode 22. On the other hand, the electric force lines 30 located near the hole edge portion of the through hole 26 leak out from the through hole 26 to the outside, and then return to the measurement electrode 22. Therefore, the electrostatic capacitance of the electrostatic sensor 7 is slightly greater than the electrostatic capacitance in the case where the electric force lines 30 leaking out from the through hole 26 do not return to the measurement electrode 22.

The upper center of FIG. 8 illustrates an approaching state. That is, a state is illustrated in which the finger 51 and the electrostatic sensor 7 are in the non-contact state and the finger 51 is approaching the vicinity of the electrostatic sensor 7. The middle center of FIG. 8 illustrates a state of the electric force lines 30 in the approaching state. The finger 51 is located on the measurement electrode 22 side with respect to the electrostatic sensor 7. The electric force lines 30 leaking out from the through hole 26 of the measurement electrode 22 are attracted by the finger 51. Thus, some of the electric force lines 30 located near the hole edge portion of the through hole 26 are also attracted by the finger 51. Then, the electric force lines 30 that leak out from the through hole 26 to the outside and then return to the measurement electrode 22 are reduced. As a result, as shown in the lower center of FIG. 8, the electrostatic capacitance of the electrostatic sensor 7 in the approaching state is reduced compared to the electrostatic capacitance of the electrostatic sensor 7 in the non-contact state.

The upper right part of FIG. 8 illustrates a “contact state.” That is, a state in which the finger 51 and the electrostatic sensor 7 are in contact with each other is illustrated. The right center of FIG. 8 illustrates a state of the electric force lines 30 in the contact state. The finger 51 is in contact with the surface of the skin material of the electrostatic sensor 7. In other words, the finger 51 is in contact with the measurement electrode 22 side of the electrostatic sensor 7. The finger 51 is located above the through hole 26 of the measurement electrode 22. In other words, the finger 51 indirectly blocks the through hole 26 of the measurement electrode 22 via the skin material. All the electric force lines 30 leaking out from the through hole 26 are attracted by the finger 51. Thus, there are no electric force lines 30 that leak out from the through hole 26 and then return to the measurement electrode 22.

On the other hand, the electric force lines 30 extend from the hole edge portion of the through hole 26 of the measurement electrode 22 toward the finger 51 that is in contact with the surface of the skin material 8. Thus, as shown in the lower right part of FIG. 8, the finger 51, which is a conductor, becomes a pseudo part of the measurement electrode 22. Since the electric force lines 30 extending from the application electrode 21 toward the measurement electrode 22 do not leak out from the through hole 26, the electrostatic capacitance of the electrostatic sensor 7 increases. As a result, the electrostatic capacitance of the electrostatic sensor 7 in the contact state is greater than the electrostatic capacitance of the electrostatic sensor 7 in the non-contact state and the approaching state where the electric force lines 30 leak out from the through hole 26.

In the electrostatic sensor 7 of this embodiment, the electrostatic capacitance of the electrostatic sensor 7 increases as the number of through holes 26 that are indirectly blocked by the conductor such as the finger 51 increases. In addition, the electrostatic sensor 7 of this embodiment is configured so that the electrostatic capacitance per unit area corresponding to a position where the conductor such as the finger 51 contacts and the electrostatic capacitance per unit area corresponding to a position where the conductor such as the finger 51 does not contact have different values.

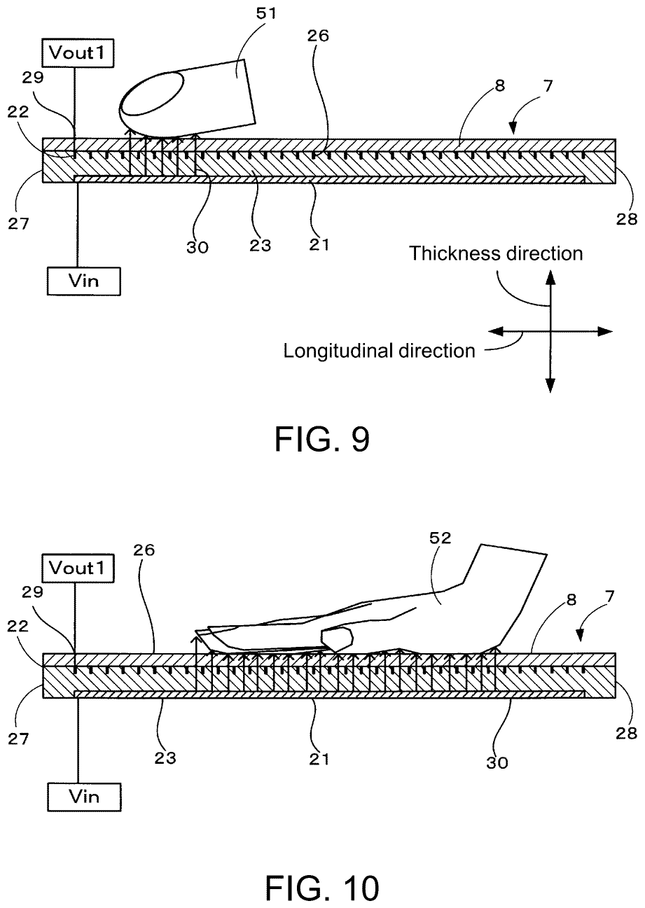

Next, the relationship between the contact area of the conductor with the electrostatic sensor 7 and the electrostatic capacitance of the electrostatic sensor 7 will be described with reference to FIG. 9 to FIG. 11. For ease of illustration, the size of the finger 51 or the hand 52 is exaggerated.

FIG. 9 shows the electrostatic sensor 7 in a state where a plurality of through holes 26 are indirectly blocked by the finger 51. In FIG. 9, five electric force lines 30 leaking out from five through holes 26 are attracted by the finger 51. However, the number of electric force lines 30 attracted by the finger 51 is not limited. As for the electric force lines 30 leaking out from the other through holes 26, although not shown in detail, the electric force lines 30 located near the center of each through hole 26 leak out to the outside of the electrostatic sensor 7, and the electric force lines 30 near the hole edge portion of each through hole 26 return to the measurement electrode 22.

FIG. 10 shows the electrostatic sensor 7 in a state where a plurality of through holes 26 are indirectly blocked by the entire hand 52. In FIG. 10, twenty electric force lines 30 are attracted by the entire hand 52. However, the number of electric force lines 30 attracted by the entire hand 52 is not limited to twenty. The electric force lines 30 leaking out from the other through holes 26 are similar to the electric force lines 30 in the case of the finger 51.

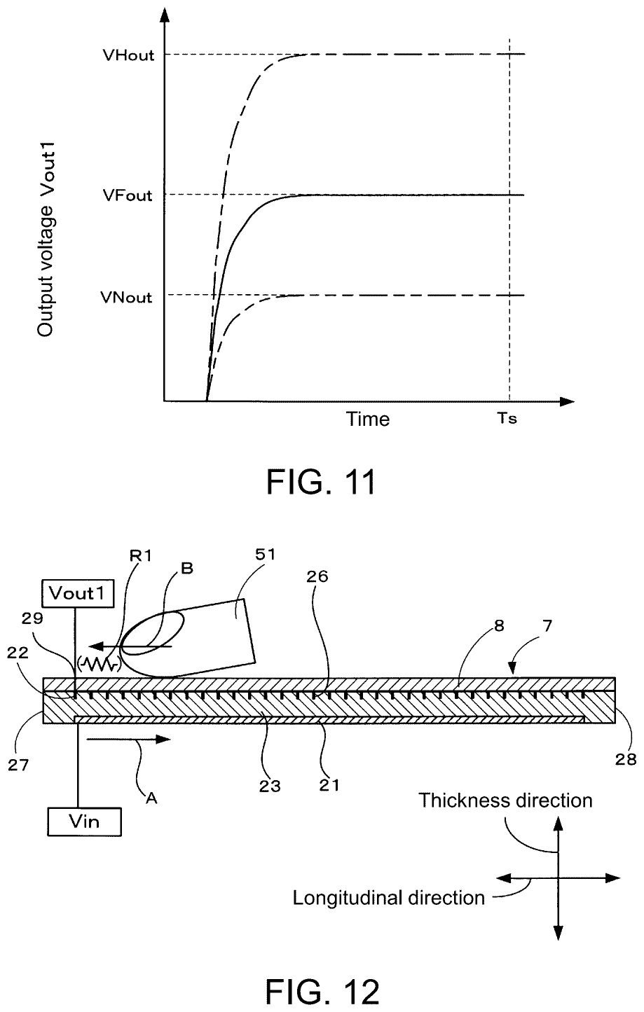

FIG. 11 shows an output voltage VHout when the hand 52 is in contact with the electrostatic sensor 7, an output voltage VFout when the finger 51 is in contact with the electrostatic sensor 7, and an output voltage VNout when the conductor such as the finger 51 or the hand 52 is not in contact with the electrostatic sensor 7. In FIG. 11, the output voltages VHout, VFout, and VNout of the electrostatic sensor 7 are compared using the output voltages VHout, VFout, and VNout at a saturation time Ts when the electrostatic capacitance of the electrostatic sensor 7 is saturated. Since the electric force lines 30 leak out from a plurality of through holes 26 to the outside when the conductor such as the finger 51 or the hand 52 is not in contact with the electrostatic sensor 7, the electrostatic capacitance of the electrostatic sensor 7 becomes the lowest, and the output voltage VNout of the electrostatic sensor 7 becomes the lowest.

When the finger 51 comes into contact with the electrostatic sensor 7, as the electric force lines 30 in the portion of the plurality of through holes 26 indirectly covered by the finger 51 are attracted by the finger 51, the electrostatic capacitance of the electrostatic sensor 7 increases, and the output voltage VFout of the electrostatic sensor 7 rises.

When the entire hand 52 comes into contact with the electrostatic sensor 7, since the hand 52 can indirectly cover more through holes 26 than the finger 51, the electrostatic capacitance of the electrostatic sensor 7 further increases, and the output voltage VHout of the electrostatic sensor 7 further rises.

The above-described saturation first potential SV1 is, for example, the first potential V1 when the potential of the measurement electrode 22 is saturated in a state where the conductor is in contact with the entire surface of the electrostatic sensor 7 on the measurement electrode 22 side. Therefore, although not shown in detail in FIG. 11, the saturation first potential SV1 is even greater than the output voltage Vout when the hand 52 is in contact with the electrostatic sensor 7.

The measuring instrument 15 can detect the area where the conductor such as the finger 51 is in contact with the electrostatic sensor 7 based on the ratio of the first potential V1 when the conductor is in contact with the electrostatic sensor 7 to the saturation first potential SV1.

### (4) Method of Detecting the Contact Position of the Conductor

Next, a method of detecting the position where the conductor exemplified by the finger 51 comes into contact with the electrostatic sensor 7 will be described with reference to FIG. 12 to FIG. 15. FIG. 12 shows a state where the finger 51 is in contact with the electrostatic sensor 7 at a position close to the first measurement position 29. In this state, when the electrostatic sensor 7 is charged by the above-described method, the current for charging the electrostatic sensor 7 flows through the application electrode 21 as shown by the arrow A, the application electrode 21 and the measurement electrode 22 are charged with electric charge, and the current flows from a portion of the measurement electrode 22 that overlaps with the finger 51 in the thickness direction to the first measurement position 29 as shown by the arrow B.

As described above, the electrical resistance value per unit length in the longitudinal direction of the measurement electrode 22 is configured to be greater than the electrical resistance value per unit length in the longitudinal direction of the application electrode 21. Thus, when the distance between the first measurement position 29 of the measurement electrode 22 and the position where the finger 51 comes into contact with the electrostatic sensor 7 changes, the electrical resistance value R1 between the first measurement position 29 and the position corresponding to the finger 51 in the measurement electrode 22 changes more significantly than in the application electrode 21. Therefore, the time constant τ of the electrostatic sensor 7 changes depending on the distance between the first measurement position 29 of the measurement electrode 22 and the position where the finger 51 comes into contact with the electrostatic sensor 7.

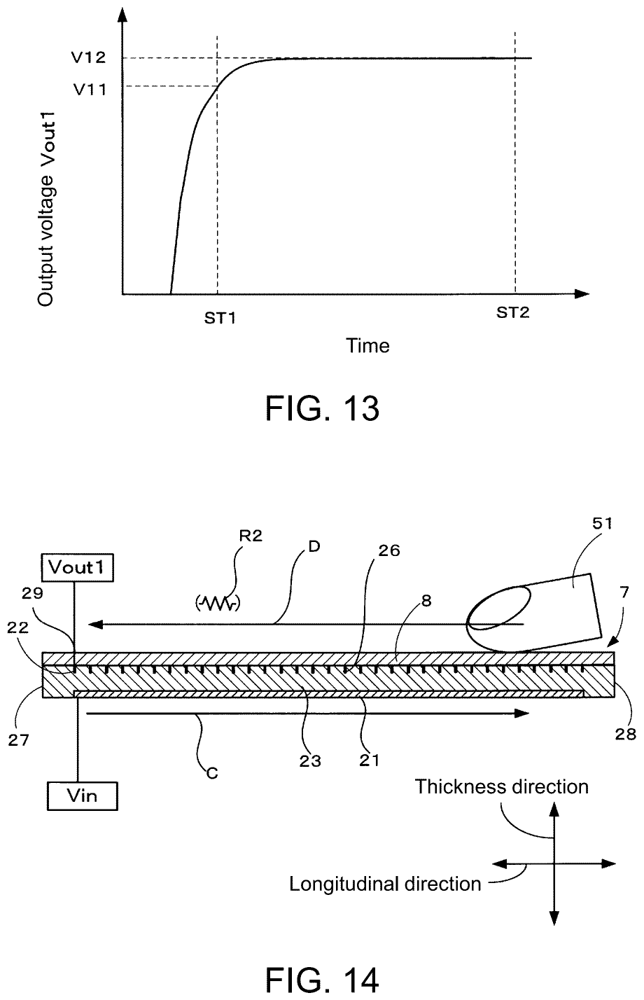

FIG. 13 shows a change over time in the output voltage Vout of the electrostatic sensor 7 in the process of charging the electrostatic sensor 7 in a state where the finger 51 is in contact with the electrostatic sensor 7 at a position close to the first measurement position 29. The output voltage Vout of the electrostatic sensor 7 increases over time and saturates. The output potential at a first sampling time point ST1 after a predetermined time has elapsed since the start of charging the electrostatic sensor 7 is set to a first potential first sampling value V11. Further, the output potential at a second sampling time point ST2 after a predetermined time has elapsed since the first sampling time point ST1 is set to a first potential second sampling value V12.

The second sampling time point ST2 is a time point at which the potential of the measurement electrode 22 is saturated. The time point at which the potential of the measurement electrode 22 is saturated refers to a state where the change in the potential of the measurement electrode 22 becomes smaller than a predetermined value after charging of the electrostatic sensor 7 is started. In this embodiment, the second sampling time point ST2 is a time point at which the time is 5 times or more the time constant τ.

The first sampling time point ST1 is a time point in a transitional state before the electrostatic sensor 7 reaches a saturated state. In this embodiment, the first sampling time point ST1 is a time point at which the time is 1 to 4 times the time constant τ.

In this embodiment, the position where the conductor such as the finger 51 comes into contact with the electrostatic sensor 7 is detected based on the ratio of the first potential first sampling value V11 to the first potential second sampling value V12. This will be described in detail below. As described above, the electrostatic sensor 7 of this embodiment is configured so that the time constant τ of the electrostatic sensor 7 changes depending on the distance between the first measurement position 29 of the measurement electrode 22 and the position where the finger 51 comes into contact with the electrostatic sensor 7. Therefore, the first potential first sampling value V11 at the first sampling time point ST1 differs depending on the distance between the first measurement position 29 of the measurement electrode 22 and the position where the finger 51 comes into contact with the electrostatic sensor 7. Thus, by calculating the ratio (V11/V12) of the first potential first sampling value V11 to the first potential second sampling value V12, it is possible to detect how far away from the first measurement point the position is, at which the conductor such as the finger 51 is in contact with the electrostatic sensor 7.

FIG. 14 shows a state where the finger 51 is in contact with the electrostatic sensor 7 at a position away from the first measurement position 29. In this state, when the electrostatic sensor 7 is charged by the above-described method, the current for charging the electrostatic sensor 7 flows through the application electrode 21 as shown by the arrow C, the application electrode 21 and the measurement electrode 22 are charged with electric charge, and the current flows from a portion of the measurement electrode 22 that overlaps with the finger 51 in the thickness direction to the first measurement position 29 as shown by the arrow D.

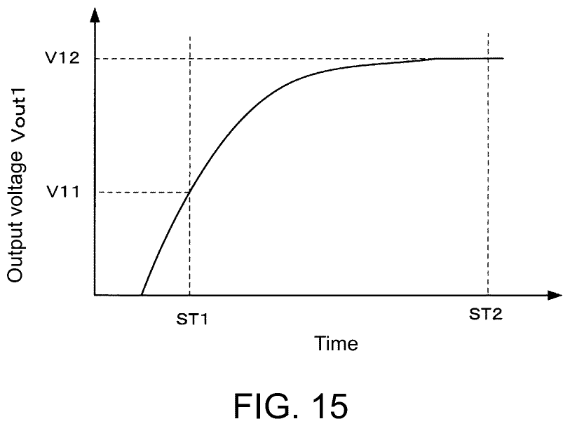

Upon comparison between FIG. 12 and FIG. 14, the distance between the first measurement point and the portion of the electrostatic sensor 7 where the finger 51 contacts is greater in FIG. 14 than in FIG. 12. Therefore, the electrical resistance value R2 of the measurement electrode 22 shown in FIG. 14 in the portion where the finger 51 contacts from the first measurement position 29 is greater than the electrical resistance value R1 of the measurement electrode 22 shown in FIG. 12 in the portion where the finger 51 contacts from the first measurement position 29 (R2>R1). As a result, the time constant τ of the electrostatic sensor 7 shown in FIG. 15 changes compared to the time constant τ of the electrostatic sensor 7 shown in FIG. 13.

FIG. 15 shows a change over time in the output voltage Vout of the electrostatic sensor 7 in the process of charging the electrostatic sensor 7 in a state where the finger 51 is in contact with the electrostatic sensor 7 at a position away from the first measurement position 29. The output voltage Vout of the electrostatic sensor 7 increases over time and saturates. The output potential at the first sampling time point ST1 after a predetermined time has elapsed since the start of charging the electrostatic sensor 7 is set to the first potential first sampling value V11. Further, the output potential at the second sampling time point ST2 after a predetermined time has elapsed since the first sampling time point ST1 is set to the first potential second sampling value V12.

In the case where the finger 51 is in contact with the electrostatic sensor 7 at a position away from the first measurement position 29 (FIG. 14), compared to the case where the finger 51 is in contact with the electrostatic sensor 7 at a position close to the first measurement position 29 (FIG. 12), the electrical resistance value R2 of the measurement electrode 22 from the first measurement position 29 to the finger 51 increases, and the time constant τ changes so that the first potential first sampling value V11 decreases. Thus, according to this embodiment, in the electrostatic sensor 7, the first potential first sampling value V11 can be made different depending on the distance where the finger 51 contacts from the first measurement position 29. As a result, by calculating the ratio (V11/V12) of the first potential first sampling value V11 to the first potential second sampling value V12, it is possible to detect how far away from the first measurement point the position is, at which the conductor such as the finger 51 is in contact with the electrostatic sensor 7.

### 5. Operation of the Contact Detecting Apparatus

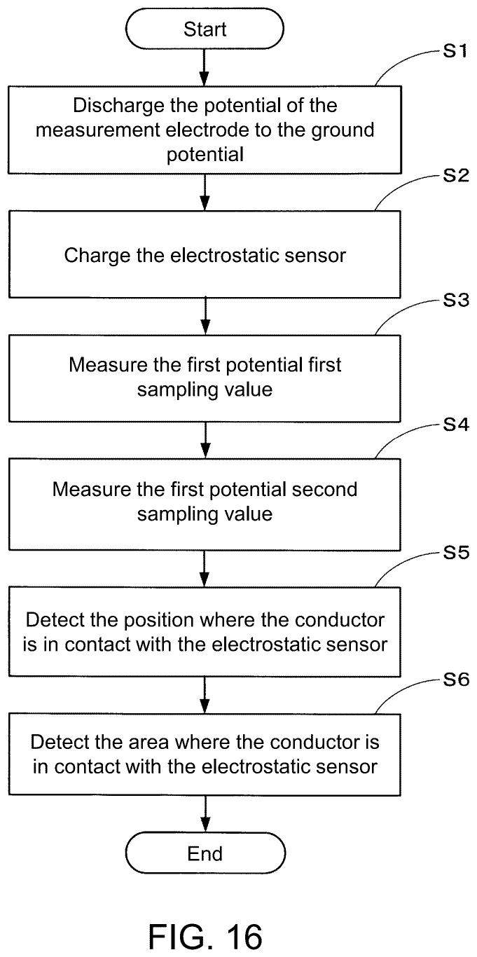

FIG. 16 is a flowchart showing the operation of the contact detecting apparatus of this embodiment. When the contact detecting apparatus is activated, a process (S1) of discharging the potential of the measurement electrode 22 to the ground potential 42 is executed. In S1, the control device 14 sets the first input switching element 11 to the open state and sets the charge/discharge switching element 13 to the closed state. Thus, the potential of the measurement electrode 22 is discharged to the ground potential 42 in a state where the input voltage Vin is not applied to the application electrode 21.

After a predetermined time has elapsed and the potential of the measurement electrode 22 has been discharged to the ground potential 42, a process (S2) of charging the electrostatic sensor 7 is executed. In S2, the control device 14 sets the charge/discharge switching element 13 to the open state and sets the first input switching element 11 to the closed state. Thus, the electrostatic sensor 7 is charged.

The process (S2) of charging the electrostatic sensor 7 is executed, and until the electrostatic sensor 7 is completely charged, the measuring instrument 15 measures the first potential sampling value at the first sampling time point ST1 after a predetermined time has elapsed since the start of charging the electrostatic sensor 7 (S3), and measures the first potential second sampling value at the second sampling time point ST2 after a predetermined time has elapsed since the first sampling time point ST1 (S4).

The measuring instrument 15 detects the position where the conductor is in contact with the electrostatic sensor 7 based on the ratio of the first potential first sampling value V11 to the first potential second sampling value V12 (S5).

The measuring instrument 15 detects the area where the conductor is in contact with the electrostatic sensor 7 based on the first potential second sampling value V12 (S6).

Through the above, the operation of the contact detecting apparatus 10 is completed.

### 6. Effects of this Embodiment

Next, the effects of this embodiment will be described. The contact detecting apparatus 10 of this embodiment includes the electrostatic sensor 7, the first bridge capacitor 12, the charge/discharge switching element 13, the control device 14, and the measuring instrument 15.

The electrostatic sensor 7 includes the application electrode 21 to which the input voltage Vin which is a constant voltage is applied from the power source 41, the measurement electrode 22 which is disposed opposite to the application electrode 21 and whose potential is measured, and the dielectric 23 which is disposed between the application electrode 21 and the measurement electrode 22, and detects contact of the conductor.

The first bridge capacitor 12 is connected in series between the first measurement position 29 of the measurement electrode 22 and the ground potential 42. The charge/discharge switching element 13 is connected in series between the measurement electrode 22 and the ground potential 42 and is connected in parallel to the first bridge capacitor 12, and discharges the potential of the measurement electrode 22 to the ground potential 42 when in the closed state.

The control device 14 executes a process of discharging the potential of the measurement electrode 22 to the ground potential 42 by setting a state where the input voltage Vin is not applied to the application electrode 21 and setting the charge/discharge switching element 13 to the closed state. After the discharging process, the control device 14 executes a process of charging the electrostatic sensor 7 by setting the charge/discharge switching element 13 to the open state and setting a state where the input voltage Vin is applied to the application electrode 21.

In the process of charging the electrostatic sensor 7, the measuring instrument 15 acquires the first potential V1 between the first measurement position 29 of the measurement electrode 22 and the first bridge capacitor 12.

The electrostatic sensor 7 is configured so that the electrostatic capacitance changes in response to at least one of the area of contact with the conductor and the distance from the conductor, and is configured so that the time constant changes due to the electrical resistance according to the distance from the first measurement position 29.

The measuring instrument 15 detects the position where the conductor is in contact with the electrostatic sensor 7 based on the first potential first sampling value V11 and the first potential second sampling value V12. The first potential first sampling value V11 is the first potential V1 acquired at the first sampling time point ST1 after a predetermined time has elapsed since the start of charging the electrostatic sensor 7 in the process of charging the electrostatic sensor 7. The first potential second sampling value V12 is the first potential V1 acquired at the second sampling time point ST2 after a predetermined time has elapsed since the first sampling time point ST1.

According to this embodiment, the position where the conductor comes into contact with the electrostatic sensor 7 can be detected with a simple configuration of one measuring instrument 15.

Further, according to this embodiment, the first sampling time point ST1 is a time point in the transitional state after a predetermined first time has elapsed since the start of charging the electrostatic sensor 7 and before the change in the potential of the measurement electrode 22 reaches the saturated state. Further, the second sampling time point ST2 is a time point later than the first sampling time point ST1 and after a predetermined second time has elapsed since the start of charging the electrostatic sensor 7. The position where the conductor comes into contact with the electrostatic sensor 7 can be detected with high accuracy based on the first potential first sampling value V11 acquired at the first sampling time point ST1 in the transitional state, and the first potential second sampling value V12 acquired at the second sampling time point ST2 after the first sampling time point ST1.

According to this embodiment, the measuring instrument 15 detects the position where the conductor comes into contact with the electrostatic sensor 7 based on the ratio of the first potential first sampling value V11 to the first potential second sampling value V12.

According to this embodiment, the electrostatic sensor 7 is formed in a shape that is elongated in the longitudinal direction, and has the first end portion 27 and the second end portion 28 at both ends in the longitudinal direction. The first bridge capacitor 12 is connected between the first end portion 27 in the longitudinal direction, which is the first measurement position 29 of the measurement electrode 22, and the ground potential 42. The first end portion 27 in the longitudinal direction of the application electrode 21 is connected to the power source 41. Since the first bridge capacitor 12 and the power source 41 are connected to the first end portion 27 of the electrostatic sensor 7, the lead wires (not shown) connected to the first bridge capacitor 12 and the power source 41 are led out from the first end portion 27 of the electrostatic sensor 7. This makes it possible to easily arrange the lead wires when attaching the electrostatic sensor 7 to the steering wheel 1.

According to this embodiment, the measurement electrode 22 and the application electrode 21 are made of an electrically conductive elastomer. Since the electrostatic sensor 7 has flexibility, it is easy to attach the electrostatic sensor 7 along the shape of the steering wheel 1.

The measurement electrode 22 of this embodiment has a plurality of through holes 26. Thus, the electric force lines 30 can leak out from the through holes 26 to the outside of the electrostatic sensor 7. As a result, the conductor comes into contact with the electrostatic sensor 7 at a position that blocks the through holes 26, so that leakage of the electric force lines 30 from the through holes 26 can be suppressed. Since the electrostatic capacitance of the electrostatic sensor 7 is increased when the conductor comes into contact with the electrostatic sensor 7, contact of the conductor with the electrostatic sensor 7 can be easily detected.

The contact detecting apparatus 10 of this embodiment includes the electrostatic sensor 7, the first bridge capacitor 12, the charge/discharge switching element 13, the control device 14, and the measuring instrument 15.

The electrostatic sensor 7 includes the application electrode 21 to which the input voltage Vin which is a constant voltage is applied from the power source 41, the measurement electrode 22 which is disposed opposite to the application electrode 21 and whose potential is measured, and the dielectric which is disposed between the application electrode 21 and the measurement electrode 22, and detects contact of the conductor with the measurement electrode 22 side.

The first bridge capacitor 12 is connected in series between the first measurement position 29 of the measurement electrode 22 and the ground potential 42. The charge/discharge switching element 13 is connected in series between the measurement electrode 22 and the ground potential 42 and is connected in parallel to the first bridge capacitor 12, and discharges the potential of the measurement electrode 22 to the ground potential 42 when in the closed state.

The control device 14 executes a process of discharging the potential of the measurement electrode 22 to the ground potential 42 by setting a state where the input voltage Vin is not applied to the application electrode 21 and setting the charge/discharge switching element 13 to the closed state. After the discharging process, the control device 14 executes a process of charging the electrostatic sensor 7 by setting the charge/discharge switching element 13 to the open state and setting a state where the input voltage Vin is applied to the application electrode 21.

In the process of charging the electrostatic sensor 7, the measuring instrument 15 acquires the first potential V1 between the first measurement position 29 of the measurement electrode 22 and the first bridge capacitor 12.

The electrostatic sensor 7 is configured so that the electrostatic capacitance changes in response to at least one of the area and the distance from the conductor, and is configured so that the time constant changes due to the electrical resistance according to the distance from the first measurement position 29.

The measuring instrument 15 detects the area where the conductor is in contact with the electrostatic sensor 7 based on the first potential second sampling value V12. The first potential second sampling value V12 is the first potential V1 acquired at the second time point that is later than the first time point after a predetermined first time has elapsed since the start of charging the electrostatic sensor 7 and when the change in the potential of the measurement electrode 22 is in the transitional state before reaching the saturated state, and after a predetermined second time has elapsed since the start of charging the electrostatic sensor 7 in the process of charging the electrostatic sensor 7.

According to this embodiment, the area where the conductor comes into contact with the electrostatic sensor 7 can be detected with a simple configuration of one measuring instrument 15.

### Second Embodiment

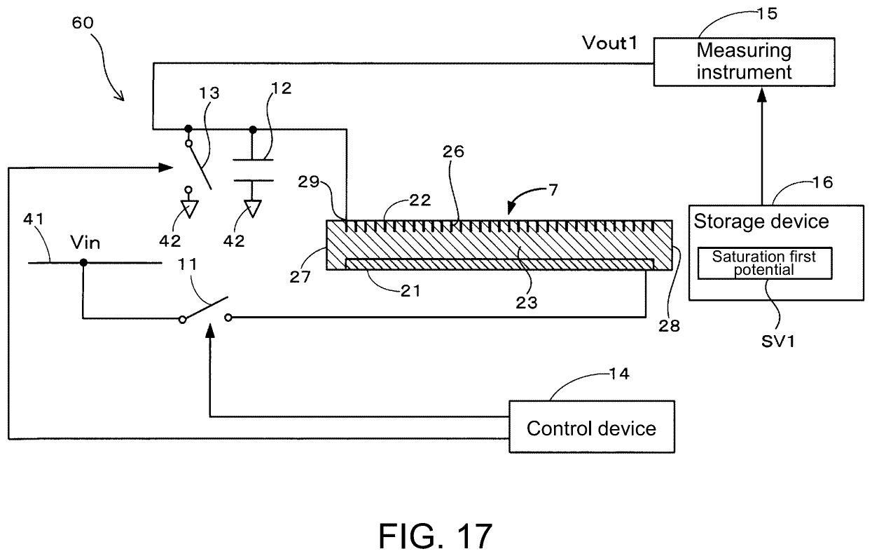

Next, a contact detecting apparatus 60 of the second embodiment will be described with reference to FIG. 17. As shown in FIG. 17, in the contact detecting apparatus 60 of this embodiment, the second end portion 28 in the longitudinal direction of the application electrode 21 is connected to the power source 41. The configuration other than that described above is substantially the same as in the first embodiment, so the same components are given the same reference numerals and repeated description will be omitted.

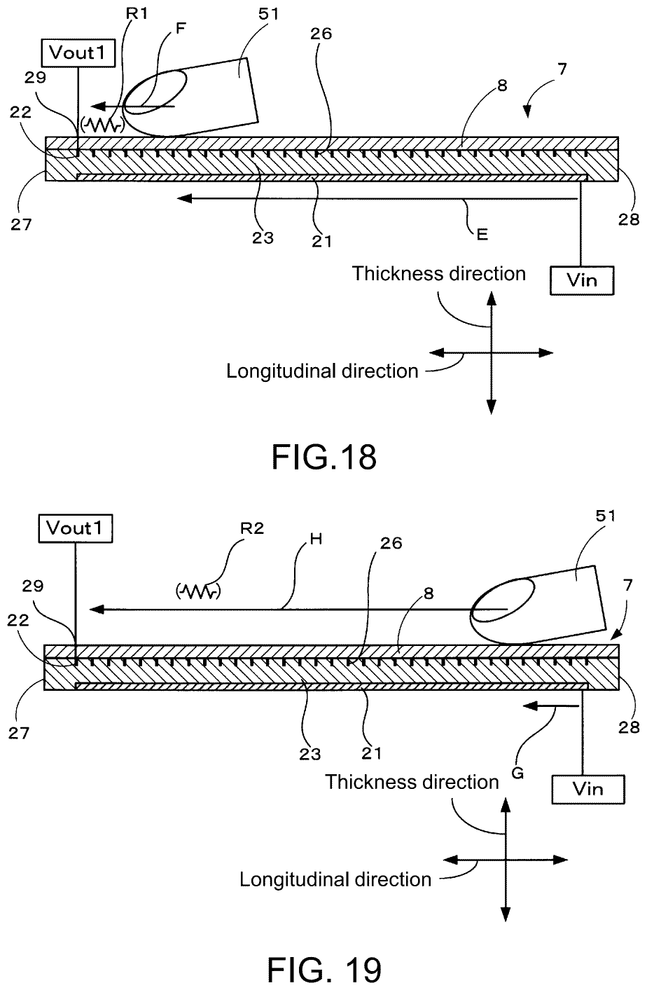

FIG. 18 shows a state where the finger 51 is in contact with the electrostatic sensor 7 at a position close to the first measurement position 29. In this state, when the electrostatic sensor 7 is charged by the above-described method, the current for charging the electrostatic sensor 7 flows through the application electrode 21 as shown by the arrow E, the application electrode 21 and the measurement electrode 22 are charged with electric charge, and the current flows from a portion of the measurement electrode 22 that overlaps with the finger 51 in the thickness direction to the first measurement position 29 as shown by the arrow F.

The output potential of the measurement electrode 22 in a state where the finger 51 is in contact with the electrostatic sensor 7 at a position close to the first measurement position 29 is the same as the graph shown in FIG. 13 of the first embodiment, so repeated description will be omitted.

FIG. 19 shows a state where the finger 51 is in contact with the electrostatic sensor 7 at a position away from the first measurement position 29. In this state, when the electrostatic sensor 7 is charged by the above-described method, the current for charging the electrostatic sensor 7 flows through the application electrode 21 as shown by the arrow G, the application electrode 21 and the measurement electrode 22 are charged with electric charge, and the current flows from a portion of the measurement electrode 22 that overlaps with the finger 51 in the thickness direction to the first measurement position 29 as shown by the arrow H.

The output potential of the measurement electrode 22 in a state where the finger 51 is in contact with the electrostatic sensor 7 at a position away from the first measurement position 29 is the same as the graph shown in FIG. 15 of the first embodiment, so repeated description will be omitted.

According to this embodiment, the electrostatic sensor 7 is formed in a shape that is elongated in the longitudinal direction, and has the first end portion 27 and the second end portion 28 at both ends in the longitudinal direction. The first bridge capacitor 12 is connected between the first end portion 27 in the longitudinal direction, which is the first measurement position 29 of the measurement electrode 22, and the ground potential 42. The second end portion 28 in the longitudinal direction of the application electrode 21 is connected to the power source 41.

According to this embodiment, the power source 41 and the first bridge capacitor 12 can be connected to different end portions of the electrostatic sensor 7. Thus, it is possible to apply the disclosure even in the case where it is difficult to lead out lead wires from the same end portion of the electrostatic sensor 7.

### Third Embodiment

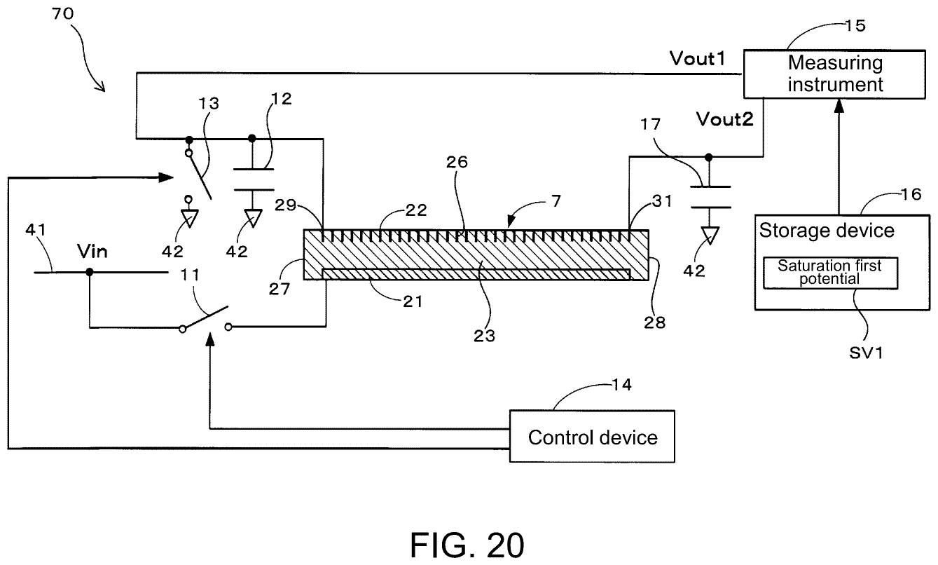

Next, a contact detecting apparatus 70 of the third embodiment will be described with reference to FIG. 20. As shown in FIG. 20, a second bridge capacitor 17 is connected in series between the second end portion 28 of the electrostatic sensor 7 of the contact detecting apparatus 70 of this embodiment and the ground potential 42. The measuring instrument 15 is configured to acquire a second potential Vout2 between the second end portion 28 of the measurement electrode 22 and the second bridge capacitor 17 in the process of charging the electrostatic sensor 7. In this embodiment, the second end portion 28 of the measurement electrode 22 is set as a second measurement position 31. The measurement electrode 22 is configured so that the electrical resistance changes depending on the distance from the second measurement position 31.

In the process of charging the electrostatic sensor 7, the measuring instrument 15 detects the position where the conductor is in contact with the electrostatic sensor 7 based on a first potential first sampling value V11, a second potential first sampling value V21, a first potential second sampling value V12, and a second potential second sampling value V22. The second potential first sampling value V21 is the second potential Vout2 acquired at the first sampling time point ST1. The second potential second sampling value V22 is the second potential V2 acquired at the second sampling time point ST2.

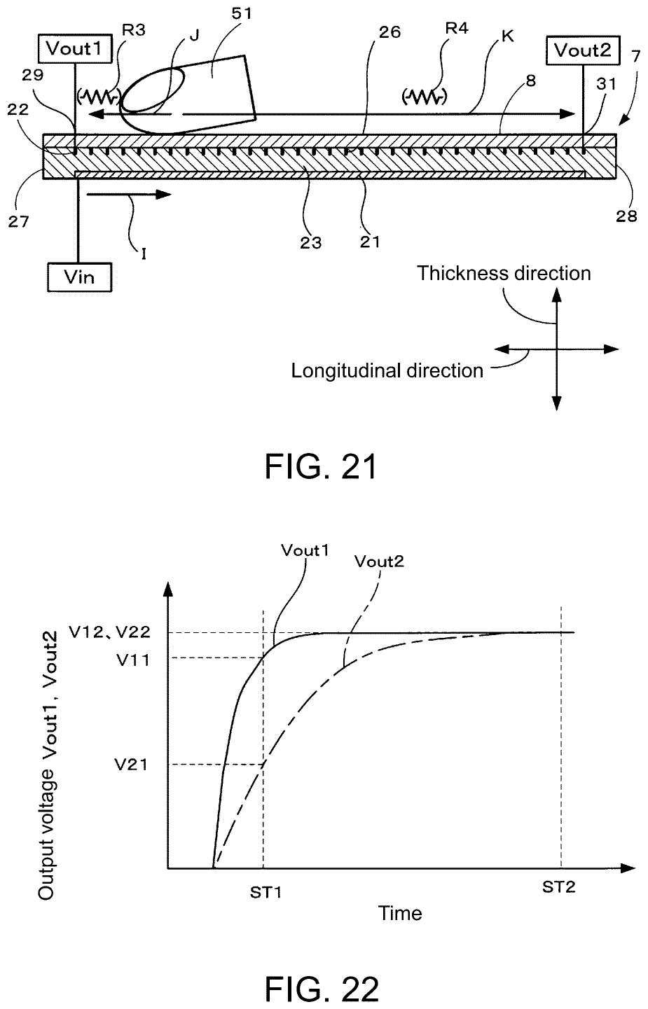

FIG. 21 shows a state where the finger 51 is in contact with the electrostatic sensor 7 at a position close to the first measurement position 29. In this state, when the electrostatic sensor 7 is charged by the above-described method, the current for charging the electrostatic sensor 7 flows through the application electrode 21 as shown by the arrow I, the application electrode 21 and the measurement electrode 22 are charged with electric charge, and the current flows from a portion of the measurement electrode 22 that overlaps with the finger 51 in the thickness direction to the first measurement position 29 as shown by the arrow J. Further, the current for charging the electrostatic sensor 7 flows from a portion of the measurement electrode 22 that overlaps with the finger 51 in the thickness direction to the second measurement position 31 as shown by the arrow K.

As shown in FIG. 21, the distance between the first measurement position 29 and the position where the finger 51 is in contact with the electrostatic sensor 7 is shorter than the distance between the second measurement position 31 and the position where the finger 51 is in contact with the electrostatic sensor 7. Therefore, the electrical resistance value R3 of the measurement electrode 22 between the first measurement position 29 and the finger 51 is smaller than the electrical resistance value R4 of the measurement electrode 22 between the second measurement position 31 and the finger 51 (R3<R4). Therefore, in the electrostatic sensor 7, the time constant t associated with the first potential V1 is different from the time constant τ associated with the second potential V2.

FIG. 22 shows changes over time in the first potential Vout1 and the second potential Vout2. The first potential Vout1 is indicated by a solid line, and the second potential Vout2 is indicated by a dashed line. Since the time constant τ associated with the first potential Vout1 and the time constant τ associated with the second potential Vout2 are different, the change over time in the second potential Vout2 is more gradual than the change over time in the first potential Vout1.

The measuring instrument 15 acquires the first potential first sampling value V11 and the first potential second sampling value V12, and calculates the ratio (V11/V12) of the first potential first sampling value V11 to the first potential second sampling value V12. Based on this ratio, the measuring instrument 15 calculates the distance between the first measurement position 29 and the position where the finger 51 is in contact with the electrostatic sensor 7.

The measuring instrument 15 acquires the second potential first sampling value V21 and the second potential second sampling value V22, and calculates the ratio (V21/V22) of the second potential first sampling value V21 to the second potential second sampling value V22. Based on this ratio, the measuring instrument 15 calculates the distance between the second measurement position 31 and the position where the finger 51 is in contact with the electrostatic sensor 7.

The measuring instrument 15 detects the position where the finger 51 is in contact with the electrostatic sensor 7 based on the distance between the first measurement position 29 and the position where the finger 51 is in contact with the electrostatic sensor 7, and the distance between the second measurement position 31 and the position where the finger 51 is in contact with the electrostatic sensor 7. According to this embodiment, the measuring instrument 15 can detect the position where the finger 51 is in contact with the electrostatic sensor 7 based on the first potential first sampling value V11 and the first potential second sampling value V12 associated with the first potential Vout1, and the second potential first sampling value V21 and the second potential second sampling value V22 associated with the second potential Vout2, so the accuracy of the contact detecting apparatus 70 can be improved.

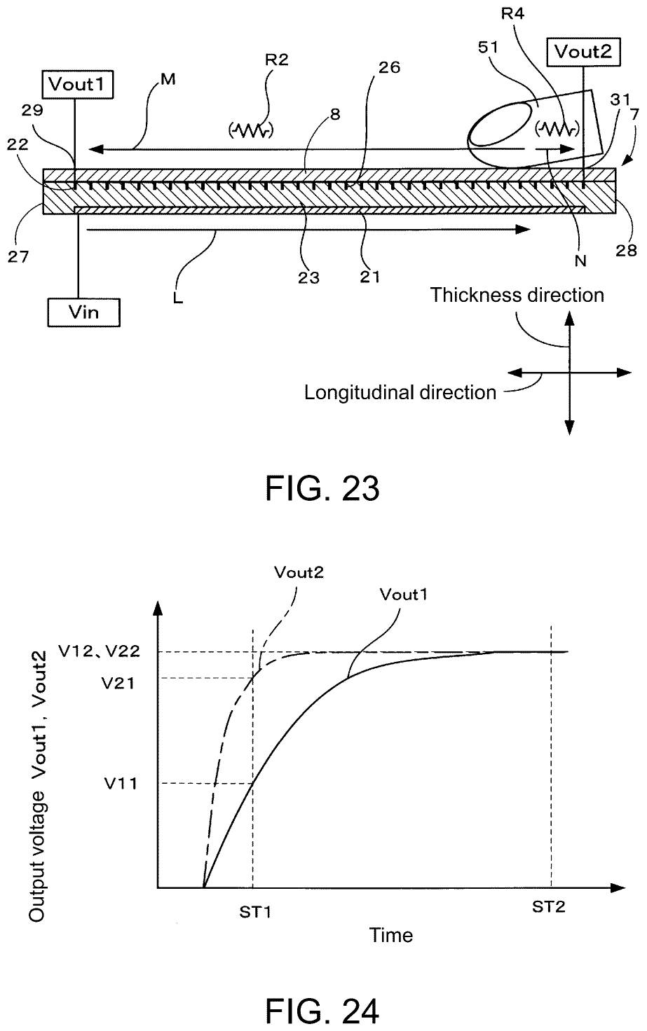

FIG. 23 shows a state where the finger 51 is in contact with the electrostatic sensor 7 at a position far from the first measurement position 29. In this state, when the electrostatic sensor 7 is charged by the above-described method, the current for charging the electrostatic sensor 7 flows through the application electrode 21 as shown by the arrow L, the application electrode 21 and the measurement electrode 22 are charged with electric charge, and the current flows from a portion of the measurement electrode 22 that overlaps with the finger 51 in the thickness direction to the first measurement position 29 as shown by the arrow M. Further, the current for charging the electrostatic sensor 7 flows from a portion of the measurement electrode 22 that overlaps with the finger 51 in the thickness direction to the second measurement position 31 as shown by the arrow N.

As shown in FIG. 23, the distance between the first measurement position 29 and the position where the finger 51 is in contact with the electrostatic sensor 7 is longer than the distance between the second measurement position 31 and the position where the finger 51 is in contact with the electrostatic sensor 7. Therefore, the electrical resistance value R2 of the measurement electrode 22 between the first measurement position 29 and the finger 51 is greater than the electrical resistance value R4 of the measurement electrode 22 between the second measurement position 31 and the finger 51 (R2>R4). Therefore, in the electrostatic sensor 7, the time constant τ associated with the first potential V1 is different from the time constant τ associated with the second potential V2.

FIG. 24 shows changes over time in the first potential V1 and the second potential V2. The first potential V1 is indicated by a solid line, and the second potential V2 is indicated by a dashed line. Since the time constant τ associated with the first potential V1 and the time constant t associated with the second potential V2 are different, the change over time in the first potential V1 is more gradual than the change over time in the second potential V2.

Similarly to the case where the finger 51 is in contact with the electrostatic sensor 7 at a position close to the first measurement position 29, the measuring instrument 15 can detect the position where the finger 51 is in contact with the electrostatic sensor 7 based on the first potential first sampling value V11 and the first potential second sampling value V12 associated with the first potential V1, and the second potential first sampling value V21 and the second potential second sampling value V22 associated with the second potential V2. Thus, the accuracy of the contact detecting apparatus 70 can be improved.

The configuration other than that described above is substantially the same as in the first embodiment, so the same components are given the same reference numerals and repeated description will be omitted.

According to this embodiment, the application electrode 21 and the measurement electrode 22 have different electrical resistances per unit length. Furthermore, the electrical resistance per unit length of the measurement electrode 22 is greater than the electrical resistance per unit length of the application electrode 21. Since the first potential V1 acquired from the first end portion 27 of the measurement electrode 22 can be made different from the second potential V2 acquired from the second end portion 28, the accuracy of detecting the contact position of the conductor can be improved.

### Fourth Embodiment

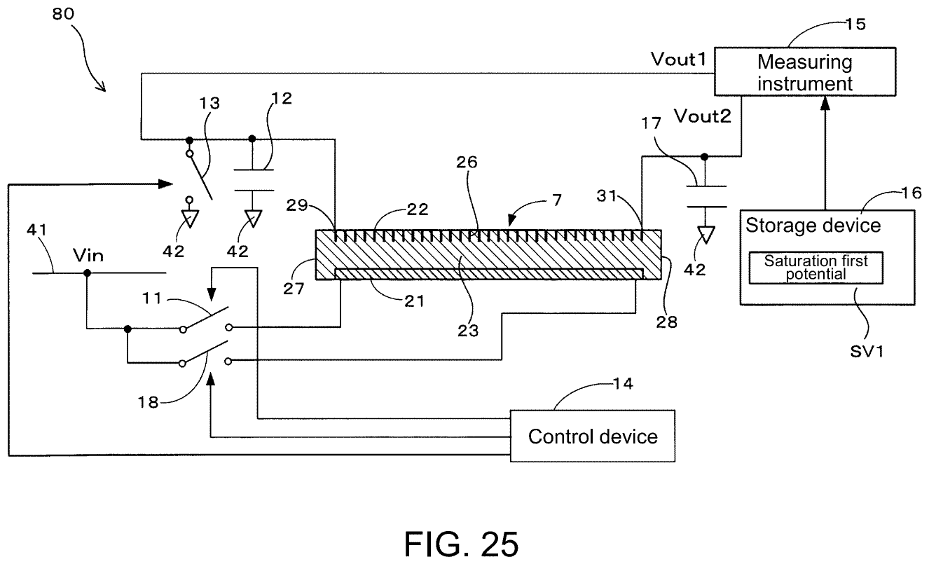

Next, the fourth embodiment will be described with reference to FIG. 25. As shown in FIG. 25, in a contact detecting apparatus 80 of this embodiment, a second input switching element 18 is connected between the second end portion 28 of the application electrode 21 and the power source 41. The second input switching element 18 turns on or off the input voltage Vin applied from the power source 41 to the second end portion 28 of the application electrode 21. The second input switching element 18 is connected in parallel to the first input switching element 11.

The control device 14 controls the second input switching element 18 to the closed state or the open state. The control device 14 sets the first input switching element 11 and the second input switching element 18 to the open state and sets the charge/discharge switching element 13 to the closed state, thereby executing a process of discharging the potential of the measurement electrode 22 to the ground potential 42. After the process of discharging the potential of the measurement electrode 22 to the ground potential 42, the control device 14 sets the charge/discharge switching element 13 to the open state, sets the first input switching element 11 to the closed state, and sets the second input switching element 18 to the open state, thereby executing a process of charging the electrostatic sensor 7 from the first end portion 27 of the electrostatic sensor 7. In addition, after the process of discharging the potential of the measurement electrode 22 to the ground potential 42, the control device 14 sets the charge/discharge switching element 13 to the open state, sets the first input switching element 11 to the open state, and sets the second input switching element 18 to the closed state, thereby executing a process of charging the electrostatic sensor 7 from the second end portion 28 of the electrostatic sensor 7.

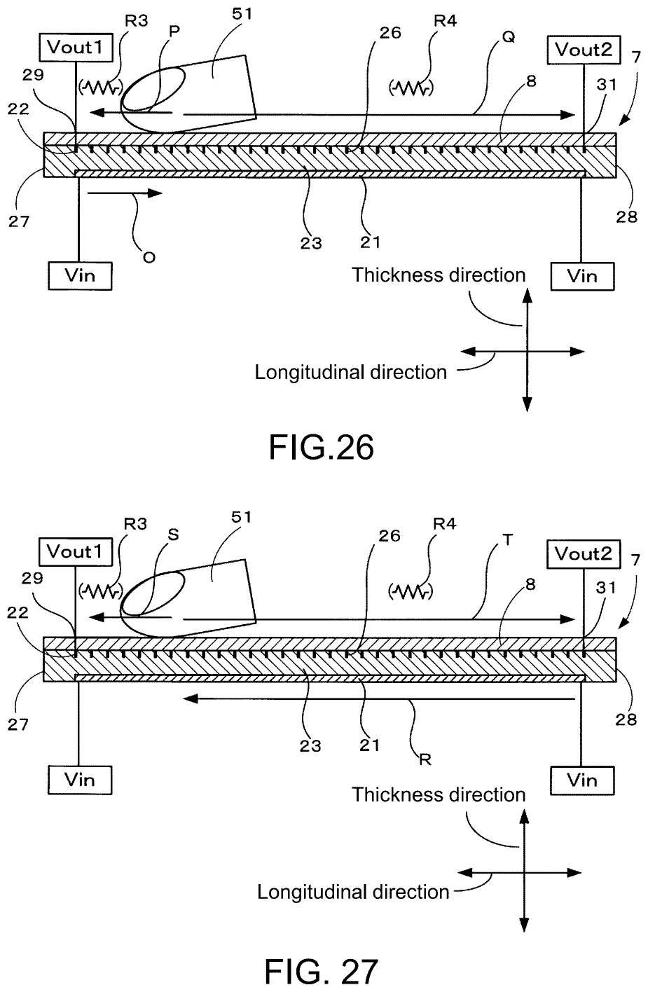

FIG. 26 shows a state where the finger 51 is in contact with the electrostatic sensor 7 at a position close to the first measurement position 29. In this state, when the electrostatic sensor 7 is charged from the first end portion 27, the current for charging the electrostatic sensor 7 flows through the application electrode 21 as shown by the arrow O, the application electrode 21 and the measurement electrode 22 are charged with electric charge, and the current flows from a portion of the measurement electrode 22 that overlaps with the finger 51 in the thickness direction to the first measurement position 29 as shown by the arrow P. Further, the current for charging the electrostatic sensor 7 flows from a portion of the measurement electrode 22 that overlaps with the finger 51 in the thickness direction to the second measurement position 31 as shown by the arrow Q.

FIG. 27 shows a state where the finger 51 is in contact with the electrostatic sensor 7 at a position close to the first measurement position 29. In this state, when the electrostatic sensor 7 is charged from the second end portion 28, the current for charging the electrostatic sensor 7 flows through the application electrode 21 as shown by the arrow R, the application electrode 21 and the measurement electrode 22 are charged with electric charge, and the current flows from a portion of the measurement electrode 22 that overlaps with the finger 51 in the thickness direction to the first measurement position 29 as shown by the arrow S. Further, the current for charging the electrostatic sensor 7 flows from a portion of the measurement electrode 22 that overlaps with the finger 51 in the thickness direction to the second measurement position 31 as shown by the arrow T.

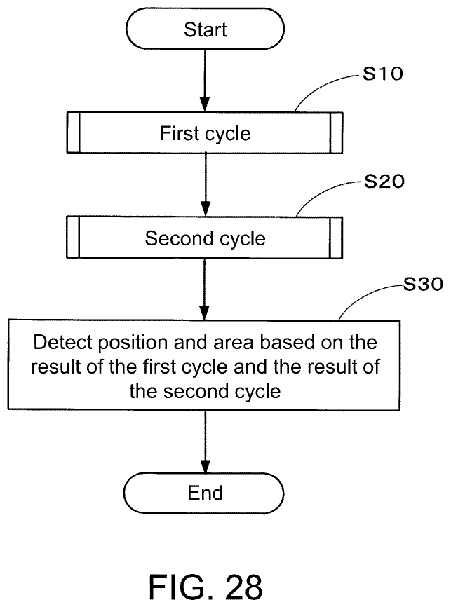

Next, the operation of the contact detecting apparatus 80 of this embodiment will be described with reference to FIG. 28. FIG. 28 shows a flowchart of the main flow of the contact detecting apparatus 80 of this embodiment. When the contact detecting apparatus 80 is activated, a first cycle is executed (S10). Next, a second cycle is executed (S20). Next, based on the result obtained in the first cycle and the result obtained in the second cycle, the position where the conductor such as the finger 51 is in contact with the electrostatic sensor 7 and the area where the conductor such as the finger 51 is in contact with the electrostatic sensor 7 are detected (S30). Through the above, the operation of the contact detecting apparatus 80 is completed.

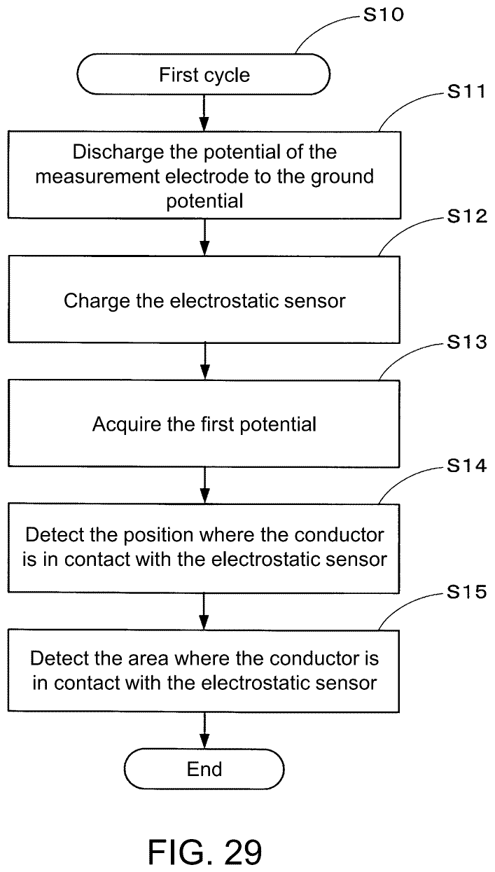

FIG. 29 shows a flowchart of the first cycle. When the first cycle is executed (S10), the control device 14 sets the second input switching element 18 to the open state. The control device 14 sets the first input switching element 11 to the open state and sets the charge/discharge switching element 13 to the closed state. Thus, the potential of the measurement electrode 22 is discharged to the ground potential 42 in a state where the input voltage Vin is not applied to the application electrode 21 (S11).

After a predetermined time has elapsed and the potential of the measurement electrode 22 has been discharged to the ground potential 42, a process (S12) of charging the electrostatic sensor 7 is executed. In S12, the control device 14 sets the charge/discharge switching element 13 to the open state and sets the first input switching element 11 to the closed state. Thus, the electrostatic sensor 7 is charged from the first end portion 27 of the electrostatic sensor 7.

The process (S12) of charging the electrostatic sensor 7 is executed, and until the electrostatic sensor 7 is completely charged, the measuring instrument 15 measures and acquires the first potential first sampling value V11 at the first sampling time point ST1 after a predetermined time has elapsed since the start of charging the electrostatic sensor 7, and measures and acquires the first potential second sampling value V12 at the second sampling time point ST2 after a predetermined time has elapsed since the first sampling time point ST1 (S13).

The measuring instrument 15 detects the position where the conductor is in contact with the electrostatic sensor 7 based on the ratio of the first potential first sampling value V11 to the first potential second sampling value V12 (S14). However, the measuring instrument 15 may detect the position where the conductor is in contact with the electrostatic sensor 7 based on the ratio of the second potential first sampling value V21 to the second potential second sampling value V22.

The measuring instrument 15 detects the area where the conductor is in contact with the electrostatic sensor 7 based on the first potential second sampling value V12 (S15). However, the measuring instrument 15 may detect the area where the conductor is in contact with the electrostatic sensor 7 based on the second potential second sampling value V22.

Through the above, the first cycle (S10) is completed.

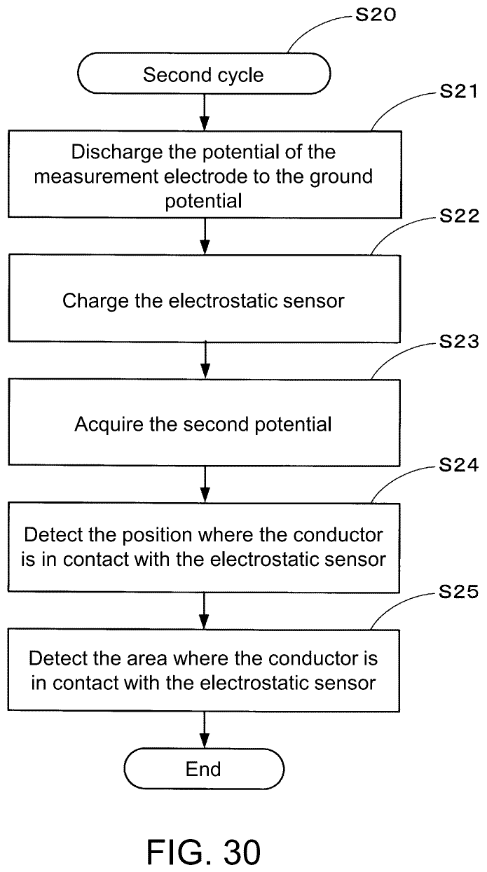

Next, FIG. 30 shows a flowchart of the second cycle. When the second cycle is executed (S20), the control device 14 sets the first input switching element 11 to the open state. The control device 14 sets the second input switching element 18 to the open state and sets the charge/discharge switching element 13 to the closed state. Thus, the potential of the measurement electrode 22 is discharged to the ground potential 42 in a state where the input voltage Vin is not applied to the application electrode 21 (S21).

After a predetermined time has elapsed and the potential of the measurement electrode 22 has been discharged to the ground potential 42, a process (S21) of charging the electrostatic sensor 7 is executed. In S21, the control device 14 sets the charge/discharge switching element 13 to the open state and sets the second input switching element 18 to the closed state. Thus, the electrostatic sensor 7 is charged from the second end portion 28 of the electrostatic sensor 7.

The process (S21) of charging the electrostatic sensor 7 is executed, and until the electrostatic sensor 7 is completely charged, the measuring instrument 15 measures and acquires the second potential first sampling value V21 at the first sampling time point ST1 after a predetermined time has elapsed since the start of charging the electrostatic sensor 7, and measures and acquires the second potential second sampling value V22 at the second sampling time point ST2 after a predetermined time has elapsed since the first sampling time point ST1 (S23).

The measuring instrument 15 detects the position where the conductor is in contact with the electrostatic sensor 7 based on the ratio of the second potential first sampling value V21 to the second potential second sampling value V22 (S24). However, the measuring instrument 15 may detect the position where the conductor is in contact with the electrostatic sensor 7 based on the ratio of the first potential first sampling value V11 to the first potential second sampling value V12.

The measuring instrument 15 detects the area where the conductor is in contact with the electrostatic sensor 7 based on the second potential second sampling value V22 (S25). However, the measuring instrument 15 may detect the area where the conductor is in contact with the electrostatic sensor 7 based on the first potential second sampling value V12.

Through the above, the second cycle (S20) is completed.

The configuration other than that described above is substantially the same as in the third embodiment, so the same components are given the same reference numerals and repeated description will be omitted.

According to this embodiment, the control device 14 executes the first cycle (S10) that includes the discharging process and the charging process following the discharging process in order for the measuring instrument 15 to acquire the first potential V1, and after the first cycle, executes the second cycle (S20) that includes the discharging process and the charging process following the discharging process in order for the measuring instrument 15 to acquire the second potential V2.

Based on the result obtained in the first cycle (S10) and the result obtained in the second cycle (S20), the position where the conductor is in contact with the electrostatic sensor 7 can be detected, so the accuracy of the contact detecting apparatus 80 can be improved. Further, based on the result obtained in the first cycle (S10) and the result obtained in the second cycle (S20), the area where the conductor is in contact with the electrostatic sensor 7 can be detected, so the accuracy of the contact detecting apparatus 80 can be improved.

### Fifth Embodiment

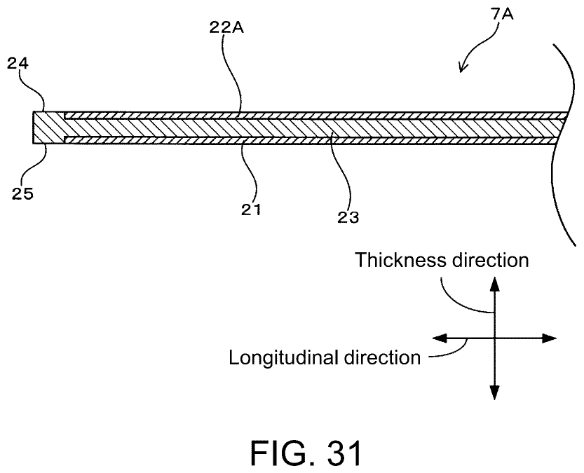

Next, the fifth embodiment will be described with reference to FIG. 31. The measurement electrode 22A of the electrostatic sensor 7A according to the fifth embodiment has the same shape and size as the application electrode 21. The measurement electrode 22A of this embodiment differs from the first embodiment in that the measurement electrode 22A does not have the through holes 26. The configuration other than that described above is substantially the same as in the first embodiment, so the same components are given the same reference numerals and repeated description will be omitted.

When a conductor such as the finger 51 comes into contact with the measurement electrode 22A side of the electrostatic sensor 7A, a kind of capacitor is formed between the measurement electrode 22A and the conductor such as the finger 51 with the skin material 8 interposed therebetween. Thus, the electrostatic capacitance of the electrostatic sensor 7A changes. Due to this change in electrostatic capacitance, the electrostatic sensor 7A is charged, so similar to the first embodiment described above, the position where the finger 51 is in contact with the electrostatic sensor 7A and the area where the finger 51 is in contact with the electrostatic sensor 7A can be detected.

The disclosure is not limited to the above-described embodiments, and includes the following aspects without departing from the gist of the disclosure.
(1) A contact detecting apparatus, including:
an electrostatic sensor for detecting contact of a conductor with a measurement electrode side, the electrostatic sensor including an application electrode to which an input voltage that is a constant voltage is applied from a power source, a measurement electrode which is disposed opposite to the application electrode and whose potential is measured, and a dielectric which is disposed between the application electrode and the measurement electrode;
a first bridge capacitor connected in series between a first measurement position of the measurement electrode and a ground potential;
a charge/discharge switching element connected in series between the measurement electrode and the ground potential and connected in parallel to the first bridge capacitor, and discharging the potential of the measurement electrode to the ground potential when in a closed state;
a control device executing a process of discharging the potential of the measurement electrode to the ground potential by setting a state in which the input voltage is not applied to the application electrode and setting the charge/discharge switching element to the closed state, and a process of charging the electrostatic sensor by setting the charge/discharge switching element to an open state and setting a state in which the input voltage is applied to the application electrode after the process of discharging; and
a measuring instrument acquiring a first potential between the first measurement position of the measurement electrode and the first bridge capacitor in the process of charging, in which
the electrostatic sensor is configured so that an electrostatic capacitance per unit area corresponding to a position where the conductor is in contact and an electrostatic capacitance per unit area corresponding to a position where the conductor is not in contact have different values,
the measurement electrode is configured so that an electrical resistance changes depending on a distance from the first measurement position, and
the measuring instrument detects a position where the conductor is in contact with the electrostatic sensor based on a first potential first sampling value and a first potential second sampling value in the process of charging, in which the first potential first sampling value is the first potential acquired at a first sampling time point after a predetermined time has elapsed since start of charging the electrostatic sensor, and the first potential second sampling value is the first potential acquired at a second sampling time point after a predetermined time has elapsed since the first sampling time point.
(2) The contact detecting apparatus according to (1) above, in which the first sampling time point is a time point in a transitional state from when charging of the electrostatic sensor is started until when a change in the potential of the measurement electrode reaches a saturated state smaller than a predetermined value, and
the second sampling time point is a time point which is later than the first sampling time point and when the potential of the measurement electrode is saturated.
(3) The contact detecting apparatus according to (2) above, in which the measuring instrument detects the position where the conductor is in contact with the electrostatic sensor based on a ratio of the first potential first sampling value to the first potential second sampling value.
(4) The contact detecting apparatus according to (2) above, in which the first sampling time point is a time point when the time is 1 to 4 times the time constant τ in the case where the electrostatic sensor is defined as an RC equivalent circuit, and the second sampling time point is a time point when the time is 5 times or more the time constant τ.
(5) The contact detecting apparatus according to (2) above, in which the measuring instrument further detects an area where the conductor is in contact with the electrostatic sensor based on the first potential second sampling value in the process of charging.
(6) The contact detecting apparatus according to (5) above, further including a storage device that stores a saturation first potential, which is the first potential when the potential of the measurement electrode is saturated, in a state where the conductor is in contact with the entire surface of the electrostatic sensor on the measurement electrode side in the process of charging, and
the measuring instrument detects the area where the conductor is in contact with the electrostatic sensor based on the first potential second sampling value in the process of charging and the saturation first potential.
(7) The contact detecting apparatus according to any one of (1) to (6) above, in which the electrostatic sensor is formed in a shape that is elongated in a longitudinal direction, and has a first end portion and a second end portion at both ends in the longitudinal direction,
the first bridge capacitor is connected between the first end portion in the longitudinal direction, which is the first measurement position of the measurement electrode, and the ground potential, and
the first end portion in the longitudinal direction of the application electrode is connected to the power source.
(8) The contact detecting apparatus according to any one of (1) to (6) above, in which the electrostatic sensor is formed in a shape that is elongated in a longitudinal direction, and has a first end portion and a second end portion at both ends in the longitudinal direction,
the first bridge capacitor is connected between the first end portion in the longitudinal direction, which is the first measurement position of the measurement electrode, and the ground potential, and
the second end portion in the longitudinal direction of the application electrode is connected to the power source.
(9) The contact detecting apparatus according to any one of (1) to (6) above, in which the electrostatic sensor is formed in a shape that is elongated in a longitudinal direction, and has a first end portion and a second end portion at both ends in the longitudinal direction,
the first bridge capacitor is connected between the first end portion in the longitudinal direction, which is the first measurement position of the measurement electrode, and the ground potential,
the contact detecting apparatus further includes a second bridge capacitor connected in series between the second end portion in the longitudinal direction, which is a second measurement position of the measurement electrode, and the ground potential,
the measurement electrode is configured so that an electrical resistance changes depending on a distance from the first measurement position, and is configured so that an electrical resistance changes depending on a distance from the second measurement position, and
the measuring instrument acquires a second potential between the second measurement position of the measurement electrode and the second bridge capacitor in the process of charging; and
detects the position where the conductor is in contact with the electrostatic sensor based on the first potential first sampling value, a second potential first sampling value, the first potential second sampling value, and a second potential second sampling value in the process of charging, in which the second potential first sampling value is the second potential acquired at the first sampling time point, and the second potential second sampling value is the second potential acquired at the second sampling time point.
(10) The contact detecting apparatus according to (9) above, in which the first sampling time point is a time point in a transitional state from when charging of the electrostatic sensor is started until when a change in the potential of the measurement electrode reaches a saturated state smaller than a predetermined value,
the second sampling time point is a time point which is later than the first sampling time point and when the potential of the measurement electrode is saturated, and
the measuring instrument further detects the area where the conductor is in contact with the electrostatic sensor based on the first potential second sampling value and the second potential second sampling value in the process of charging.
(11) The contact detecting apparatus according to (9) above, in which the control device executes a first cycle which includes the process of discharging and the process of charging following the process of discharging in order for the measuring instrument to acquire the first potential, and
after the first cycle, executes a second cycle which includes the process of discharging and the process of charging following the process of discharging in order for the measuring instrument to acquire the second potential.
(12) The contact detecting apparatus according to any one of (1) to (6) above, in which the measurement electrode and the application electrode are made of an electrically conductive elastomer.
(13) The contact detecting apparatus according to (12) above, in which the application electrode and the measurement electrode have different electrical resistances per unit length.
(14) The contact detecting apparatus according to (13) above, in which the electrical resistance per unit length of the measurement electrode is greater than the electrical resistance per unit length of the application electrode.
(15) The contact detecting apparatus according to (14) above, in which the measurement electrode has a plurality of through holes.
(16) A contact detecting apparatus, including:
an electrostatic sensor for detecting contact of a conductor with a measurement electrode side, the electrostatic sensor including an application electrode to which an input voltage that is a constant voltage is applied from a power source, a measurement electrode which is disposed opposite to the application electrode and whose potential is measured, and a dielectric which is disposed between the application electrode and the measurement electrode;
a first bridge capacitor connected in series between a first measurement position of the measurement electrode and a ground potential;
a charge/discharge switching element connected in series between the measurement electrode and the ground potential and connected in parallel to the first bridge capacitor, and discharging the potential of the measurement electrode to the ground potential when in a closed state;
a control device executing a process of discharging the potential of the measurement electrode to the ground potential by setting a state in which the input voltage is not applied to the application electrode and setting the charge/discharge switching element to the closed state, and a process of charging the electrostatic sensor by setting the charge/discharge switching element to an open state and setting a state in which the input voltage is applied to the application electrode after the process of discharging; and
a measuring instrument acquiring a first potential between the first measurement position of the measurement electrode and the first bridge capacitor in the process of charging, in which
the electrostatic sensor is configured so that an electrostatic capacitance per unit area corresponding to a position where the conductor is in contact and an electrostatic capacitance per unit area corresponding to a position where the conductor is not in contact have different values,
the measurement electrode is configured so that an electrical resistance changes depending on a distance from the first measurement position, and
the measuring instrument detects an area where the conductor is in contact with the electrostatic sensor based on a first potential saturation sampling value which is the first potential acquired at a time point when the potential of the measurement electrode is saturated and smaller than a predetermined value in a process of charging.

What is claimed is:

1. A contact detecting apparatus (10, 60, 70, 80), comprising:
an electrostatic sensor (7, 7A) for detecting contact of a conductor (51, 52), the electrostatic sensor (7, 7A) comprising an application electrode (21) to which an input voltage (Vin) that is a constant voltage is applied from a power source (41), a measurement electrode (22, 22A) which is disposed opposite to the application electrode and whose potential is measured, and a dielectric (23) which is disposed between the application electrode and the measurement electrode;
a first bridge capacitor (12) connected in series between a first measurement position (29) of the measurement electrode and a ground potential (42);
a charge/discharge switching element (13) connected in series between the measurement electrode and the ground potential and connected in parallel to the first bridge capacitor, and discharging the potential of the measurement electrode to the ground potential when in a closed state;
a control device (14) executing a process (S1) of discharging the potential of the measurement electrode to the ground potential by setting a state in which the input voltage is not applied to the application electrode and setting the charge/discharge switching element to the closed state, and a process (S2) of charging the electrostatic sensor by setting the charge/discharge switching element to an open state and setting a state in which the input voltage is applied to the application electrode after the process of discharging; and
a measuring instrument (15) acquiring a first potential (V1) between the first measurement position of the measurement electrode and the first bridge capacitor in the process of charging,
wherein the electrostatic sensor is configured so that an electrostatic capacitance changes in response to at least one of an area of contact with the conductor and a distance from the conductor, and is configured so that a time constant (τ) changes due to an electrical resistance according to a distance from the first measurement position, and
the measuring instrument detects a position where the conductor is in contact with the electrostatic sensor based on a first potential first sampling value (V11) and a first potential second sampling value (V12) in the process of charging, wherein the first potential first sampling value is the first potential acquired at a first sampling time point (ST1) after a predetermined time has elapsed since start of charging the electrostatic sensor, and the first potential second sampling value is the first potential acquired at a second sampling time point (ST2) after a predetermined time has elapsed since the first sampling time point.

2. The contact detecting apparatus according to claim 1, wherein the first sampling time point is a time point in a transitional state after a predetermined first time has elapsed since the start of charging the electrostatic sensor and before a change in the potential of the measurement electrode reaches a saturated state, and
the second sampling time point is a time point later than the first sampling time point and after a predetermined second time has elapsed since the start of charging the electrostatic sensor.

3. The contact detecting apparatus according to claim 2, wherein the measuring instrument detects the position where the conductor is in contact with the electrostatic sensor based on a ratio of the first potential first sampling value to the first potential second sampling value.

4. The contact detecting apparatus according to claim 1, wherein the electrostatic sensor is formed in a shape that is elongated in a longitudinal direction, and has a first end portion (27) and a second end portion (28) at both ends in the longitudinal direction,
the first bridge capacitor is connected between the first end portion in the longitudinal direction, which is the first measurement position of the measurement electrode, and the ground potential, and
the first end portion in the longitudinal direction of the application electrode is connected to the power source.

5. The contact detecting apparatus according to claim 1, wherein the electrostatic sensor is formed in a shape that is elongated in a longitudinal direction, and has a first end portion and a second end portion at both ends in the longitudinal direction,
the first bridge capacitor is connected between the first end portion in the longitudinal direction, which is the first measurement position of the measurement electrode, and the ground potential, and
the second end portion in the longitudinal direction of the application electrode is connected to the power source.

6. The contact detecting apparatus according to claim 1, wherein the electrostatic sensor is formed in a shape that is elongated in a longitudinal direction, and has a first end portion and a second end portion at both ends in the longitudinal direction,
the first bridge capacitor is connected between the first end portion in the longitudinal direction, which is the first measurement position of the measurement electrode, and the ground potential,
the contact detecting apparatus further comprises a second bridge capacitor (17) connected in series between the second end portion in the longitudinal direction, which is a second measurement position of the measurement electrode, and the ground potential,
the measurement electrode is configured so that an electrical resistance changes depending on a distance from the first measurement position, and is configured so that an electrical resistance changes depending on a distance from the second measurement position, and
the measuring instrument acquires a second potential (V2) between the second measurement position of the measurement electrode and the second bridge capacitor in the process of charging; and
detects the position where the conductor is in contact with the electrostatic sensor based on the first potential first sampling value, a second potential first sampling value (V21), the first potential second sampling value, and a second potential second sampling value (V22) in the process of charging, wherein the second potential first sampling value is the second potential acquired at the first sampling time point, and the second potential second sampling value is the second potential acquired at the second sampling time point.

7. The contact detecting apparatus according to claim 6, wherein the control device executes a first cycle which comprises the process of discharging and the process of charging following the process of discharging in order for the measuring instrument to acquire the first potential, and
after the first cycle, executes a second cycle which comprises the process of discharging and the process of charging following the process of discharging in order for the measuring instrument to acquire the second potential.

8. The contact detecting apparatus according to claim 1, wherein the measurement electrode and the application electrode are made of an electrically conductive elastomer.

9. The contact detecting apparatus according to claim 8, wherein the application electrode and the measurement electrode have different electrical resistances per unit length.

10. The contact detecting apparatus according to claim 9, wherein the electrical resistance per unit length of the measurement electrode is greater than the electrical resistance per unit length of the application electrode.

11. The contact detecting apparatus according to claim 10, wherein the measurement electrode has a plurality of through holes (26).

12. A contact detecting apparatus, comprising:
an electrostatic sensor for detecting contact of a conductor with a measurement electrode side, the electrostatic sensor comprising an application electrode to which an input voltage that is a constant voltage is applied from a power source, a measurement electrode which is disposed opposite to the application electrode and whose potential is measured, and a dielectric which is disposed between the application electrode and the measurement electrode;
a first bridge capacitor connected in series between a first measurement position of the measurement electrode and a ground potential;
a charge/discharge switching element connected in series between the measurement electrode and the ground potential and connected in parallel to the first bridge capacitor, and discharging the potential of the measurement electrode to the ground potential when in a closed state;
a control device executing a process of discharging the potential of the measurement electrode to the ground potential by setting a state in which the input voltage is not applied to the application electrode and setting the charge/discharge switching element to the closed state, and a process of charging the electrostatic sensor by setting the charge/discharge switching element to an open state and setting a state in which the input voltage is applied to the application electrode after the process of discharging; and
a measuring instrument acquiring a first potential between the first measurement position of the measurement electrode and the first bridge capacitor in the process of charging,
wherein the electrostatic sensor is configured so that an electrostatic capacitance changes in response to at least one of an area and a distance from the conductor, and is configured so that a time constant changes due to an electrical resistance according to a distance from the first measurement position, and
the measuring instrument detects an area where the conductor is in contact with the electrostatic sensor based on a first potential second sampling value, wherein the first potential second sampling value is the first potential acquired at a second time point which is later than a first time point after a predetermined first time has elapsed since start of charging the electrostatic sensor and when a change in the potential of the measurement electrode is in a transitional state before reaching a saturated state, and after a predetermined second time has elapsed since the start of charging the electrostatic sensor in the process of charging.

13. The contact detecting apparatus according to claim 12, wherein the measuring instrument acquires a first potential first sampling value which is the first potential at the first time point in the process of charging, and detects a position where the conductor is in contact with the electrostatic sensor based on the first potential first sampling value and the first potential second sampling value.
